(19) United States
(12) Patent Application Publication
(10) Pub. No.: US 2026/0210860 A1
(43) Pub. Date: Jul. 23, 2026

(54) METHODS AND COMPOSITIONS FOR ASSESSING THE PERFORMANCE OF INSTRUMENTS ADAPTED FOR SINGLE-MOLECULE TRACKING

(71) Applicant: EIKON THERAPEUTICS, INC., Millbrae, CA (US)

(72) Inventors: Markus SEEGER, Millbrae, CA (US); Joshua ISAACS, Millbrae, CA (US)

(73) Assignee: EIKON THERAPEUTICS, INC., Millbrae, CA (US)

(21) Appl. No.: 19/564,475

(22) Filed: Mar. 12, 2026

Related U.S. Application Data
(63) Continuation of application No. PCT/US2024/046375, filed on Sep. 12, 2024.
(60) Provisional application No. 63/538,056, filed on Sep. 12, 2023.

(51) Int. Cl. G01N 21/64

(52) U.S. Cl. CPC G01N 21/6458; G01N 21/6428; G01N 21/6452; G01N 2021/6432

(57) ABSTRACT

The presently disclosed subject matter relates to methods and compositions for assessing the performance of instruments adapted to track single molecules within complex systems.

### CROSS-REFERENCE TO RELATED APPLICATIONS

This application is a continuation of Internation Patent Application No. PCT/US2024/046375, filed on Sep. 12, 2024, which claims priority to U.S. Provisional Application No. 63/538,056, filed on Sep. 12, 2023, the contents of each of which are hereby incorporated by reference in their entireties, and to each of which priority is claimed.

### TECHNICAL FIELD

The subject matter described herein relates to methods and compositions for assessing the performance of instruments adapted to track single molecules.

### BACKGROUND

The movement of molecules is profoundly influenced by interactions with their surroundings. Single-molecule tracking (SMT) is one method for capturing molecule movement as a reporter of activity. In SMT, a fluorescent molecule of interest is imaged at high spatiotemporal resolution to track its movement. Such tracking can occur in relatively simple systems, e.g., a simple buffer solution, or in complex systems, e.g., a live cell. The information embedded in these tracks has been used to investigate diverse molecular attributes including protein-protein interactions, e.g., interactions mediating signal transduction, inter-organelle communication, nuclear organization, and transcription regulation. Given the nature of the imaging performed in the context of SMT analyses, the SMT instrument platforms require precise performance assessments. Accordingly, there remains a need in the art for efficient and effective methods and compositions for precisely assessing the performance of such instruments adapted for SMT analyses.

### SUMMARY OF THE INVENTION

In a first aspect, the present disclosure is directed to methods and compositions for assessing the performance of instruments adapted to track single molecules.

In certain embodiments, the present disclosure is directed to compositions for assessing the performance of instruments adapted to track single molecules within complex systems comprising a plurality of individually addressable reference samples. In certain embodiments, the individually addressable reference samples used in the compositions for assessing the performance of instruments adapted to track single molecules are selected from: reference samples comprising a plurality of spatially-stationary optical point sources; reference samples comprising a plurality of diffusible optical point sources; reference samples comprising a homogenous optical volume; and reference samples comprising one or more resolution test patterns.

In certain embodiments, the reference samples used in the compositions of the present disclosure are contained in individually addressable sample chambers of a sample vessel. In certain embodiments, each of such sample chambers comprises: a bottom surface made of optically permissive material; and a vertical wall formed along a perimeter of the bottom surface forming a cavity therewithin bounded by a bottom end that is closed, and a top end that is open.

In certain embodiments, the present disclosure is directed to compositions comprising a plurality of individually addressable reference samples comprising a plurality of spatially-stationary optical point sources, wherein the plurality of spatially-stationary optical point sources is immobilized in a polymer. In certain embodiments, the polymer in which the plurality of spatially-stationary optical point sources is immobilized is a hydrogel. In certain embodiments, the polymer in which the plurality of spatially-stationary optical point sources is immobilized is a polysaccharide hydrogel, a polyacrylamide (PAA) hydrogel, a polyacrylic acid hydrogel, a polymethyl acrylate hydrogel, a polyvinyl alcohol hydrogel, a polyvinylpyrrolidone hydrogel, a polyethylene glycol hydrogel, an agarose hydrogel, a gelatin hydrogel, a collagen hydrogel, an alginate hydrogel, or a combination thereof. In certain embodiments, the polymer in which the plurality of spatially-stationary fluorescent point sources are immobilized is a polystyrene, an epoxy, a polyvinyl acetate, an ethylene vinyl acetate, a polyurethane, a polytetrafluoroethylene, a polycarbonate, or a polyvinyl butyral. In certain embodiments, the polymer in which the plurality of spatially-stationary optical point sources is immobilized is degassed, or homogenized and degassed.

In certain embodiments, the present disclosure is directed to compositions comprising a plurality of individually addressable reference samples comprising a plurality of spatially-stationary optical point sources, wherein the spatially-stationary optical point sources are immobilized in the polymer by covalent conjugation, adsorption, electrostatic binding, or a combination thereof. In certain embodiments, the polymer in which the plurality of spatially-stationary optical point sources is immobilized comprises a 3-dimensional lattice.

In certain embodiments of the present disclosure, the plurality of spatially-stationary optical point sources is a plurality of spatially-stationary fluorescent point sources. In certain embodiments of the present disclosure, the plurality of spatially-stationary fluorescent point sources is comprised of quantum dots (Qdot). In certain embodiments, the quantum dots have an emission maximum from about 400 nm to about 720 nm. In certain embodiments, the quantum dots have an emission maximum from about 420 nm to about 480 nm. In certain embodiments, the quantum dots have an emission maximum of 450 nm. In certain embodiments, the quantum dots have an emission maximum from about 500 nm to about 550 nm. In certain embodiments, the quantum dots have an emission maximum of 525 nm. In certain embodiments, the quantum dots have an emission maximum of 545 nm. In certain embodiments, the quantum dots have an emission maximum from about 525 nm to about 575 nm. In certain embodiments, the quantum dots have an emission maximum of 565 nm. In certain embodiments, the quantum dots have an emission maximum from about 575 nm to about 650 nm. In certain embodiments, the quantum dots have an emission maximum of 585 nm. In certain embodiments, the quantum dots have an emission maximum of 605 nm. In certain embodiments, the quantum dots have an emission maximum of 625 nm. In certain embodiments, the quantum dots have an emission maximum from about 650 nm to about 720 nm. In certain embodiments, the quantum dots have an emission maximum of 655 nm. In certain embodiments, the quantum dots have an emission maximum of 705 nm.

In certain embodiments, the plurality of spatially-stationary fluorescent point sources disposed in the plurality of individually addressable reference samples is comprised of nanodiamonds. In certain embodiments, the nanodiamond spatially-stationary fluorescent point sources have an emission maximum from about 400 nm to about 720 nm. In certain embodiments, the nanodiamond spatially-stationary fluorescent point sources have an emission maximum from about 400 nm to about 500 nm. In certain embodiments, the nanodiamond spatially-stationary fluorescent point sources have an emission maximum of about 415 nm. In certain embodiments, the nanodiamond spatially-stationary fluorescent point sources have an emission maximum from about 500 nm to about 550 nm. In certain embodiments, the nanodiamond spatially-stationary fluorescent point sources have an emission maximum from about 550 nm to about 600 nm. In certain embodiments, the nanodiamond spatially-stationary fluorescent point sources have an emission maximum of 510 nm. In certain embodiments, the nanodiamond spatially-stationary fluorescent point sources have an emission maximum of 575 nm. In certain embodiments, the nanodiamond spatially-stationary fluorescent point sources have an emission maximum from about 600 nm to about 700 nm. In certain embodiments, the nanodiamond spatially-stationary fluorescent point sources have an emission maximum of 638 nm.

In certain embodiments, the present disclosure is directed to compositions comprising a plurality of individually addressable reference samples comprising a plurality of diffusible optical point sources, wherein the diffusible optical point sources are disposed within a solution. In certain embodiments, the solution in which the diffusible optical point sources are disposed comprises Tris:HCl, DMSO, DMEM, DPBS, or H₂O. In certain embodiments, the H₂O is distilled H₂O or deionized H₂O. In certain embodiments, the solution in which the diffusible optical point sources are disposed comprises polytungstate. In certain embodiments, the solution in which the diffusible optical point sources are disposed comprises TWEEN® 20 (Polysorbate 20). In certain embodiments, the solution in which the diffusible optical point sources are disposed comprises Triton X-100® (2-[4-(2,4,4-trimethylpentan-2-yl)phenoxy]ethanol).

In certain embodiments, the present disclosure is directed to compositions comprising a plurality of individually addressable reference samples comprising a plurality of diffusible optical point sources, wherein the diffusible optical point sources each comprise a conjugated compound. In certain embodiments, the compound to which the diffusible optical point sources are conjugated is a protein, a polyethylene glycol, a polysaccharide, an oligonucleotide, a polyamine, or a polyaminoacid, or derivatives thereof, and analogs thereof.

In certain embodiments, the compound to which the diffusible optical point sources are conjugated is a protein selected from egg albumin, serum albumin, and avidin.

In certain embodiments, the compound to which the diffusible optical point sources are conjugated is a polyaminoacid selected from, a polylysine, a polyhistidine, or a polyglutamic acid, a polyaspartic acid, derivatives thereof, and analogs thereof. In certain embodiments, the compound to which the diffusible optical point sources are conjugated is a polyethylene glycol, derivatives thereof, and analogs thereof, having a molecular weight from about 200 Da to about 6000 Da.

In certain embodiments of the present disclosure wherein the reference sample comprises a plurality of diffusible optical point sources and where the diffusible optical point sources each comprise a conjugated compound, the reference sample is contained in an individually addressable chamber and the compounds conjugated to the diffusible optical point sources are operably linked to a surface of the chamber that is in contact with the reference sample. In certain embodiments of the present disclosure wherein the reference sample comprises a plurality of diffusible optical point sources and where the diffusible optical point sources each comprise a conjugated compound, the reference sample is contained in an individually addressable chamber and the compound is conjugated to a surface of the chamber and to the diffusible fluorescent point source. In certain embodiments of the present disclosure wherein the reference sample comprises a plurality of diffusible optical point sources and where the diffusible optical point sources each comprise a conjugated compound, wherein the compound is conjugated to a surface of the chamber and to the diffusible optical point source, the compound is conjugated on a first end to the bottom surface of the sample chamber, and on a second end to the diffusible optical point source. In certain embodiments, the conjugation is by covalent bonding, adsorption, electrostatic bonding, hydrophobic bonding, or a combination thereof.

In certain embodiments, the present disclosure is directed to compositions comprising a plurality of individually addressable reference samples comprising a plurality of diffusible optical point sources, wherein the diffusible optical point sources are disposed within a polymer. In certain embodiments, the polymer in which the plurality of diffusible optical point sources is disposed is a hydrogel. In certain embodiments, the hydrogel in which the plurality of diffusible optical point sources is disposed is a polysaccharide hydrogel, a polyacrylamide hydrogel, a polyacrylic acid hydrogel, a polymethyl acrylate hydrogel, a polyvinyl alcohol hydrogel, a polyvinylpyrrolidone hydrogel, a polyethylene glycol hydrogel, an agarose hydrogel, a gelatin hydrogel, a collagen hydrogel, an alginate hydrogel, or a combination thereof. In certain embodiments, the hydrogel in which the plurality of diffusible optical point sources is disposed is a polyacrylamide hydrogel, or an agarose hydrogel. In certain embodiments, the hydrogel in which the plurality of diffusible optical point sources is disposed is a polystyrene, an epoxy, a polyvinyl acetate, an ethylene vinyl acetate, a polyurethane, a polytetrafluoroethylene (PTFE), a polycarbonate, or a polyvinyl butyral.

In certain embodiments of the present disclosure, the plurality of diffusible optical point sources is a plurality of diffusible fluorescent point sources. In certain embodiments of the present disclosure, the plurality of diffusible fluorescent point sources comprises quantum dots. In certain embodiments, the quantum dots have an emission maximum from about 400 nm to about 720 nm. In certain embodiments, the quantum dots have an emission maximum from about 420 nm to about 480 nm. In certain embodiments, the quantum dots have an emission maximum of 450 nm. In certain embodiments, the quantum dots have an emission maximum from about 500 nm to about 550 nm. In certain embodiments, the quantum dots have an emission maximum of 525 nm. In certain embodiments, the quantum dots have an emission maximum of 545 nm. In certain embodiments, the quantum dots have an emission maximum from about 525 nm to about 575 nm. In certain embodiments, the quantum dots have an emission maximum of 565 nm. In certain embodiments, the quantum dots have an emission maximum from about 575 nm to about 650 nm. In certain embodiments, the quantum dots have an emission maximum of 585 nm. In certain embodiments, the quantum dots have an emission maximum of 605 nm. In certain embodiments, the quantum dots have an emission maximum of 625 nm. In certain embodiments, the quantum dots have an emission maximum from about 650 nm to about 720 nm. In certain embodiments, the quantum dots have an emission maximum of 655 nm. In certain embodiments, the quantum dots have an emission maximum of 705 nm.

In certain embodiments, the plurality of diffusible fluorescent point sources comprise nanodiamonds. In certain embodiments, the nanodiamonds have an emission maximum from about 400 nm to about 720 nm. In certain embodiments, the nanodiamonds have an emission maximum from about 400 nm to about 500 nm. In certain embodiments, the nanodiamonds have an emission maximum of about 415 nm. In certain embodiments, the nanodiamonds have an emission maximum from about 500 nm to about 550 nm. In certain embodiments, the nanodiamonds have an emission maximum of 510 nm. In certain embodiments, the nanodiamonds have an emission maximum from about 550 nm to about 600 nm. In certain embodiments, the nanodiamonds have an emission maximum of 575 nm. In certain embodiments, the nanodiamonds have an emission maximum from about 600 nm to about 700 nm. In certain embodiments, the nanodiamonds have an emission maxima of 638 nm.

In certain embodiments, the present disclosure is directed to compositions comprising a plurality of individually addressable reference samples comprising homogenous optical volumes, wherein the homogenous optical volumes are each disposed within a matrix. In certain embodiments, the matrix in which the homogenous optical volume is disposed is a solution or a polymer. In certain embodiments, the matrix in which the homogenous optical volume is disposed is a solution that comprises Tris:HCl, DMSO, DMEM, DPBS, or H₂O. In certain embodiments, the H₂O is distilled H₂O or deionized H₂O. In certain embodiments, the polymer in which the homogenous optical volume is disposed is a sol-gel, a gel, or a solid. In certain embodiments, the polymer matrix in which the homogenous optical volume is disposed is a hydrogel. In certain embodiments, the hydrogel in which the homogenous optical volume is disposed is a polysaccharide hydrogel, a polyacrylamide hydrogel, a polyacrylic acid hydrogel, a polymethyl acrylate hydrogel, a polyvinyl alcohol hydrogel, a polyvinylpyrrolidone hydrogel, a polyethylene glycol hydrogel, an agarose hydrogel, a gelatin hydrogel, a collagen hydrogel, an alginate hydrogel, or a combination thereof. In certain embodiments, the polymer matrix in which the homogenous optical volume is disposed is a polystyrene, an epoxy, a polyvinyl acetate, an ethylene vinyl acetate, a polyurethane, a polytetrafluoroethylene (PTFE), a polycarbonate, or a polyvinyl butyral. In certain embodiments, the hydrogel in which the homogenous optical volume is disposed is a polyacrylamide hydrogel, or an agarose hydrogel. In certain embodiments, the hydrogel in which the homogenous optical volume is disposed is a polystyrene, an epoxy, a polyvinyl acetate, an ethylene vinyl acetate, a polyurethane, a polytetrafluoroethylene (PTFE), a polycarbonate, or a polyvinyl butyral.

In certain embodiments, the homogenous optical volume is a homogenous fluorescent volume. In certain embodiments, the homogenous fluorescent volume comprises a fluorescent molecule. In certain embodiments, the homogenous fluorescent volume comprises a fluorescent molecule having an emission maximum from about 400 nm to about 720 nm. In certain embodiments, the homogenous fluorescent volume comprises a fluorescent molecule having an emission maximum from about 420 nm to about 480 nm. In certain embodiments, the homogenous fluorescent volume comprises a fluorescent molecule having an emission maximum of 450 nm. In certain embodiments, the homogenous fluorescent volume comprises a fluorescent molecule having an emission maximum from about 500 nm to about 550 nm. For example, in a particular embodiment the fluorescent molecule is Fluorescein having an emission maximum of 517 nm. In certain embodiments, the homogenous fluorescent volume comprises a fluorescent molecule having an emission maximum from about 525 nm to about 575 nm. For example, in a particular embodiment the fluorescent molecule is Rhodamine B having an emission maximum of 550 nm. In certain embodiments, the homogenous fluorescent volume comprises a fluorescent molecule having an emission maximum of 565 nm. In certain embodiments, the homogenous fluorescent volume comprises a fluorescent molecule having an emission maximum from about 575 nm to about 650 nm. In certain embodiments, the homogenous fluorescent volume comprises a fluorescent molecule having an emission maximum from about 650 nm to about 720 nm. In certain embodiments, the fluorescent molecule is a quenched fluorescent molecule.

In certain embodiments, the present disclosure is directed to compositions comprising a plurality of individually addressable reference samples comprising one or more resolution test patterns adapted for evaluating one or more of a resolution test pattern, a field distortion test pattern, or a parfocal stability test pattern. For example, but not by way of limitation, the one or more resolution test patterns are selected from absorptive patterns, reflective patterns, and birefringent patterns. Exemplary resolution test patterns known in the art include, but are not limited to, the following: the USAF 1951 resolution test chart; the NBS 1952 resolution test chart; the Ronchi ruling target; and the Sector Star target.

In certain embodiments, the present disclosure is directed to methods of assessing a plurality of performance characteristics of instruments adapted to track single molecules using a composition comprising a plurality of individually addressable reference samples. In certain embodiments, the individually addressable reference samples used in the compositions for assessing the performance of instruments adapted to track single molecules are selected from: reference samples comprising a plurality of spatially-stationary optical point sources; reference samples comprising a plurality of diffusible optical point sources; reference samples comprising a homogenous optical volume; and reference samples comprising one or more resolution test patterns. In certain embodiments of such methods, the instrument is a microscope. In certain embodiments, such methods comprise: aligning the objective lens of the microscope to one of the plurality of individually addressable reference samples, wherein the vertical axis of the objective is perpendicular to the horizontal axis of the sample; and analyzing one or more imaging parameters based on the image captured by the microscope; analyzing one or more acquisition parameters based on the image captured by the microscope; analyzing one or more SMT analysis parameters based on the image captured by the microscope; or a combination thereof; repeating the aligning and analyzing steps for a plurality of the individually addressable reference samples; and integrating the analysis performed for the plurality of individually addressable references samples to thereby assess the plurality of microscope performance characteristics.

In certain embodiments, the methods of the present disclosure are directed to assessing a plurality of performance characteristics of instruments adapted to track single molecules, where the methods comprise analyzing one or more imaging parameters. In certain embodiments, the imaging parameters comprise: laser parameters, alignment parameters, camera parameters, detection parameters, or a combination thereof. In certain embodiments, analyzing the laser parameters comprises analyzing one or more of a laser wavelength, a laser pulse, and a laser pulse duration. In certain embodiments, analyzing the alignment parameters comprises analyzing one or both of light-sheet characteristics and a focal plane. In certain embodiments, analyzing the light-sheet characteristics comprises analyzing one or more of: light-sheet thickness; light-sheet uniformity, light-sheet angle of inclination; and intensity density of the light-sheet. In certain embodiments, analyzing the camera parameters comprises analyzing one or more of a noise pattern, a relative alignment, an orientation, or a magnification of the camera. In certain embodiments, analyzing the detection parameters comprises analyzing one or more of aberrations, sensitivity, and resolution. In certain embodiments, analyzing aberrations comprises analyzing one or more of spherical aberrations, chromatic aberrations, coma aberrations, and trefoil aberrations. In certain embodiments, analyzing the focal plane comprises analyzing the position, flatness, orientation relative to the sample and detector, and thickness of the optical focal plane.

In certain embodiments, the methods of the present disclosure are directed to assessing a plurality of performance characteristics of instruments adapted to track single molecules, where the methods comprise analyzing one or more acquisition parameters of the instrument. In certain embodiments, analyzing the acquisition parameters of the instrument comprises analyzing the temporal parameters and/or spatial parameters. In certain embodiments, analyzing the temporal parameters comprises analyzing one or more of frame rate, exposure time, number of frames, or channels. In certain embodiments, analyzing the spatial parameters comprises analyzing one or more of a field of view (FOV) size on a detector chip, a FOV position and orientation on a detector chip, a FOV position or a FOV orientation in the sample.

In certain embodiments, the methods of the present disclosure are directed to assessing a plurality of performance characteristics of instruments adapted to track single molecules, where the methods comprise analyzing one or more SMT parameters of the instrument. In certain embodiments, analyzing SMT parameters comprises analyzing single-molecule localization and/or single-molecule tracking. In certain embodiments, analyzing single-molecule localization comprises analyzing one or more of a localization error, a number of spots, and a signal to noise ratio (SNR). In certain embodiments, analyzing single-molecule tracking comprise analyzing one or more of a number of tracks, a track length, a jump length, and mean posterior diffusion coefficient.

In certain embodiments, the methods of the present disclosure are directed to assessing a plurality of performance characteristics of instruments adapted to track single molecules, where the performance characteristics are selected from: oblique line scanning (OLS) alignment characteristics: rotation relative to the camera, position in the FOV, angle of inclination, excitation fluence; oblique line scanning (OLS) homogeneity characteristics: coefficient of variation (CV), Sag (which refers to the vertical difference in level between points of support (e.g., the laser line at the edges of a field of view) and the lowest point of the line), fringes, thickness, mechanical and temperature effects; detection characteristics: background and camera noise, point spread function (PSF), signal to noise ratio (SNR), diffusion characteristics, optical aberrations, correction collar settings, spatial resolution, Strehl ratio, FOV homogeneity, camera rotation relative to the sample, focal plane position and orientation relative to the objective and detector, focal plane thickness and flatness; acquisition characteristics: plate position and level, scanning amplitude, scanning offset, galvanometer (galvo) scanning, camera synchronization. In certain embodiments, comparing the instrument's performance (the imaging parameters, the acquisition parameters and the single molecule tracking (SMT) parameters) with reference parameter values, wherein a deviation from the reference parameter value indicates a need for adjustment of the microscope and the method further comprises automated adjustment of the microscope based on the integrated analysis alone or based on the comparison to the reference.

### BRIEF DESCRIPTION OF THE DRAWINGS

FIG. 1 illustrates compositions of the present disclosure comprising: (1) diffusible fluorescent point sources; (2) spatially-stationary fluorescent point sources; or (3) controlled dynamic fluorescent point sources.

FIG. 2 illustrates a composition of the present disclosure comprising a plurality of individually addressable reference samples present in specific locations, e.g., at specific locations in a multi-well microplate. FIG. 2 also indicates exemplary performance characteristics that can be analyzed in connection with the compositions of the instant disclosure. The specific location at which any particular performance characteristic is analyzed is not fixed and alternative arrangements are within the scope of the instant disclosure.

FIG. 3 depicts a schematic of a SMT workflow according to particular embodiments of the present disclosure.

FIGS. 4A-4D depict schematic illustrations of an exemplary image acquisition system of the present disclosure with the X-Z plane visible (FIGS. 4A and 4D) or the Y-Z plane visible (FIGS. 4B and 4C), according to particular embodiments.

FIGS. 5A-5E depict illustrations of example opto-mechanical assemblies of the present disclosure, according to particular embodiments.

FIGS. 6A-6B depict various measures indicating that the image acquisition systems and workflows of the present disclosure are amenable to robust high throughput single molecule tracking (htSMT) analysis. FIG. 6A illustrates cross-sectional features of example light beams for OLS and alternative approaches, according to particular embodiments. FIG. 6B illustrates rolling shutter operation, depicting an example of relative timing and synchronization of sensor exposure and sweeping of sample illumination, according to particular embodiments.

FIGS. 7A-7E depict representative results for alignment parameter analysis. FIG. 7A depicts alignment analysis for an example angle of inclination (AOI) of a light-sheet. FIG. 7B depicts alignment analysis for an example galvo scanning synchronization. FIG. 7C depicts alignment procedure for an iterative example galvo scanning synchronization. FIG. 7D depicts alignment analysis for an example spatial distribution of SNR and PSF. FIG. 7E depicts distributions and statistics of example light sheet according to particular embodiments of this disclosure.

FIG. 8 depicts a schematic of an exemplary sample handling system of the present disclosure.

FIG. 9 illustrates an exemplary system for high-throughput single-molecule imaging platform that measures protein movement in living cells.

FIG. 10 illustrates data flow through an exemplary system for a high-throughput single-molecule imaging platform that measures protein movement in living cells.

FIG. 11 depicts a plurality of images illustrating differences between mask categories and instance or semantic masks.

FIG. 12 illustrates an example computer-implemented environment in connection with the subject matter described herein.

FIG. 13 is a diagram illustrating a sample computing device architecture for implementing various aspects described herein.

It should be noted that figures provided may be illustrated schematically rather than literally or precisely; components and aspects of the figures may also not necessarily be to scale. Moreover, while like reference numerals may designate corresponding parts throughout the different views in many cases, like parts may not always be provided with like reference numerals in each view.

### DETAILED DESCRIPTION

The presently disclosed subject matter relates to methods and compositions for assessing the performance of instruments adapted to track single molecules. For example, but not by way of limitation, the present disclosure is directed to compositions for assessing the performance of instruments adapted to track single molecules within complex systems comprising a plurality of individually addressable reference samples as well as methods of using such compositions. In certain embodiments, the individually addressable reference samples used in the compositions for assessing the performance of instruments adapted to track single molecules are selected from: reference samples comprising a plurality of spatially-stationary optical, e.g., fluorescent, point sources; reference samples comprising a plurality of diffusible optical, e.g., fluorescent, point sources; reference samples comprising a homogenous optical, e.g., fluorescent, volume; and reference samples comprising a plurality absorptive or reflective patterns. In certain embodiments, the compositions and methods of the present disclosure will employ multiple reference samples including one or more of reference samples comprising a plurality of spatially-stationary optical, e.g., fluorescent, point sources; reference samples comprising a plurality of diffusible optical, e.g., fluorescent, point sources; reference samples comprising a homogenous optical, e.g., fluorescent, volume; and reference samples comprising a plurality absorptive or reflective patterns.

The subject matter of the present disclosure is described with reference to the figures, where reference numbers are used to designate similar or equivalent elements throughout. The figures are not drawn to scale and they are provided merely to illustrate aspects disclosed herein. Several disclosed aspects are described below with reference to exemplary hardware, software, and applications for illustration. It should be understood that numerous specific details, relationships and methods are set forth to provide a more complete understanding of the subject matter disclosed herein. For purposes of clarity of disclosure and not by way of limitation, the detailed description is divided into the following subsections:
1. Definitions
2. Assessing Performance of Instruments Adapted for Single Molecule Tracking
3. Exemplary Single Molecule Tracking Analysis Hardware
4. Exemplary Single Molecule Tracking Analysis Software
5. Examples

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the presently disclosed subject matter. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other instances “comprising,” “consisting of”, and “consisting essentially of,” the instances or elements presented herein, whether explicitly set forth or not.

For the recitation of numeric ranges herein, each intervening number within the range is explicitly contemplated with the same degree of precision. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein, the term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

As defined herein, “movement” of a molecule refers to a change in the position and/or orientation of a molecule. In certain embodiments, a molecule's movement can be quantified by analysis of changes in spatial coordinates in sequential timepoints, e.g., the analysis of trajectories. Movement characterized in this way can also include, but not be limited to, measurements of diffusion coefficients. For example, but not by way of limitation, the measurement can be of a diffusion coefficient maximum likelihood estimator, defined as an estimate of the maximum likelihood diffusion coefficient for the plurality of trajectories under a single-state diffusion model with constant localization error. In certain embodiments, molecule movement may be measured through analysis of the product of the link-generating algorithm. Movement characterized in this way can include, but not be limited to, the mean posterior diffusion coefficient, or the mean of the posterior probability distribution of coefficients from a probabilistic linking algorithm. Movement characterized in this way can include, but not be limited to, the geometric mean posterior diffusion coefficient, or the mean of the log-scaled posterior probability distribution of coefficients from a probabilistic linking algorithm. Movement characterized in this way may include, but not be limited to, measurements of the jump length distribution. For example, for a given a set of protein displacements between one timepoint and a subsequent timepoint, a histogram can be constructed of the probability of each of the displacement lengths (“jump lengths”). Quantiles of this distribution can be used to describe the motion of the molecule. In certain embodiments the quantile used is the median of the jump length distribution. In certain embodiments, the quantile used is the 3^{rd} quartile of the jump length distribution. Movement characterized in this way can include, but not be limited to, measurements of the mean squared displacement as defined by the average of the square of all displacements in a trajectory, averaged over the plurality of trajectories. Movement characterized in this way can also include, but not be limited to, measurements of the trajectory length or distribution of trajectory lengths. Movement characterized in this way can also include, but not be limited to, measurements of the mean radius of gyration, as defined by the root mean square distance of all coordinates in a trajectory from the center of mass of the set of points contained in the trajectory, averaged over the plurality of trajectories. Movement characterized in this way can also include, but not be limited to, measurements of the mean bond angle, defined by the angle formed from three sequential spatial coordinates averaged over the plurality of trajectories. In certain embodiments, molecule movement can be measured through model-dependent analysis of the plurality of trajectories. Movement characterized in this way can include, but not be limited to, the fraction of immobile molecules (“f_{bound}”) as defined by two-state model fitting.

As used herein, the term “movement” encompasses changes in the direction as well as changes, both increases and decreases, in the speed at which a target is traveling. Accordingly, tracking movement can, in certain embodiments, include determining that the target is not moving, e.g., when the target either is or is essentially in a static bound state. As noted above, such movement can be characterized in a variety of ways, including, but not limited to, quantifying (a) a diffusion coefficient of the plurality of trajectories obtained from a maximum likelihood estimator; (b) geometric mean posterior diffusion coefficient of the plurality of trajectories; (c) the median of the jump length distribution of the plurality of trajectories; (d) 3rd quartile of the jump length distribution of the plurality of trajectories; (e) median radius of gyration of the plurality of trajectories; (f) mean posterior diffusion coefficient of the plurality of trajectories; (g) mean squared displacement of the plurality of trajectories; (h) median bond angle of the plurality of trajectories; or (i) the trajectory length of the plurality of trajectories.

As used herein the term “trajectory” refers to the set of spatial coordinates corresponding to the position of an observation of a molecule linked in time. In certain embodiments, a plurality of trajectories can be constructed algorithmically by linking a plurality of molecules whose positions have been determined in successive time points. In certain embodiments, a plurality of trajectories can be constructed conservatively by linking only spots within a fixed search radius when no other links are plausible. In certain embodiments, a plurality of trajectories can be constructed probabilistically.

In certain embodiments, a molecule's movement can be quantified by analysis of changes in the rotational motion of the molecule at sequential time points. For example, but not by way limitation, movement characterized in this way can be determined as a measurement of fluorescent polarization. Fluorescence polarization is a measurement of changes in the orientation of a target molecule or test molecule over the time period between absorption and emission events. For example, but not by way of limitation, if a fluorophore is excited with polarized light, a slowly rotating molecule comprising that fluorophore will emit more light retaining the original polarization than a faster-rotating molecule. Thus, by measuring the fluorescent polarization, it is possible to determine a target molecule's or a test molecule's rotational motion and make use of that information to calculate measurements of rotational motion.

In certain embodiments, the measurements of rotational motion described herein will be calculated as a function of anisotropy decay time. The systems described herein allow for detection of anisotropy decay time and which can be calculated using strategies known in the art, e.g., those outlined in “Time-Dependent Anisotropy Decays” Lakowicz, J. R. (eds) Principles of Fluorescence Spectroscopy. Springer, Boston, MA. https://doi.org/10.1007/978-0-387-46312-4_11), which is hereby incorporated by reference in its entirety. In certain embodiments, the measurements of rotational motion described herein will be calculated as a function of the intensity change of fluorescence polarization. The systems described herein allow for detection of intensity changes of fluorescence polarization, which can then be calculated using strategies known in the art. In certain embodiments, the measurements of rotational motion described herein will be calculated as a function of the relaxation time of rotational diffusion. The systems described herein allow for detection of intensity changes of relaxation time of rotational diffusion, which can then be calculated using strategies known in the art.

As used herein, the movement being detected, including, but not limited to, any change in movement, can occur in response to any environmental or other factor (e.g., presence of a test molecule). For example, but not by way of limitation, the movement, or lack thereof, can be elicited by: (A) molecule addition; (B) a change in temperature; (C) a change in oxygen concentration, e.g., introduction of a hypoxic condition; (D) mechanical stress; (E) a change in pH; (F) a change in light exposure (e.g., increasing or decreasing intensity); and/or (G) change in solution composition.

As used herein, the term “plurality” refers to a number larger than one. In certain embodiments, the term “plurality of target molecules” refers to a number of target molecules larger than one. For example, but not by way of limitation, a “plurality of target molecules” can include at least about 10, at least about 50, at least about 100, at least about 200, at least about 300, at least about 400, at least about 500, at least about 600, at least about 700, at least about 800, at least about 900, at least about 1000, at least about 5,000, at least about 10,000, at least about 50,000, at least about 100,000, at least about 500,000 or at least about 1,000,000 target molecules. In certain embodiments, the term “plurality of test molecules” refers to a number of test molecules larger than one. For example, but not by way of limitation, a plurality of test molecules can include at least about 10, at least about 50, at least about 100, at least about 200, at least about 300, at least about 400, at least about 500, at least about 600, at least about 700, at least about 800, at least about 900, at least about 1000, at least about 5,000, at least about 10,000, at least about 50,000, at least about 100,000, at least about 500,000 or at least about 1,000,000 test molecules

As used herein, the term “fluorescent protein” refers to any protein that emits a fluorescent signal. In certain instances, the fluorescent emission occurs in response to exposure to light of a particular wavelength. An example of a naturally occurring fluorescent protein is Green fluorescent protein (GFP). In certain instances, however, a protein of interest can be adapted to emit a fluorescent signal via the introduction of an encoded fluorescent tag, i.e., a protein sequence is fused to a protein of interest to render it fluorescent. In certain instances, a protein of interest can be adapted to emit a fluorescent signal through binding of a fluorescent ligand. Nonlimiting examples of such encoded fluorescent tags include: Halo tags, SNAP tags, CLIP tags, TMP tags, and SunTags. Additionally, or alternatively, a protein of interest can be adapted to emit a fluorescent signal via coupling the protein to a fluorescent dye molecule, e.g., amine-or sulfhydryl-reactive dyes.

As used herein, the term “compound” refers to any chemically-defined entity. In certain instances, the compound can be a molecule less than 1000 Da, i.e., a “small molecule”. In certain instances, the compound can be a macromolecule such as a nucleic acid. In certain instances, the nucleic acid can have a defined sequence. In certain instances, the nucleic acid comprises; (A) ribonucleic acid (RNA), including, for example, modified RNA; (B) deoxyribonucleic acid (DNA), including, for example, modified DNA; as well as (C) combinations of (A) and (B). In certain instances, the nucleic acid will be a single-stranded or double-stranded small interfering nucleic acid (e.g., a double-stranded siRNA), an antisense oligonucleotide, a ribozyme, a microRNA, or an aptamer. In certain instances, the compound can be a protein. For example, but not by way of limitation, the protein compounds of the present disclosure encompass signaling proteins, e.g., protein hormones, cytokines, kinases, phosphatases, and other enzymes and transcription factors, as well as antibodies, contractile proteins, structural proteins, storage proteins, and transport proteins. In certain instances, a compound can refer to a mixture of molecules, e.g., a mixture of defined composition.

As used herein, the term “uniform intensity” refers, in connection with the intensity of light, e.g., light directed to a sample plane, to light that differs in intensity no more than 5%, in certain instances, 10%, in certain instances, or 15%, in certain instances.

As used herein, the term “uniform intensity” refers, in connection with signal to noise (SNR), to a pixel-wise SNR within a field of view (FOV) where the range of possible values are comprised between 0.5 to 1 standard deviations from the mean SNR.

### 2. Assessing Performance of Instruments Adapted for Single Molecule Tracking

### 2.1 Reference Sample Compositions

In certain embodiments, the present disclosure is directed to compositions for assessing the performance of instruments adapted to track single molecules within complex systems comprising a plurality of individually addressable reference samples. In certain embodiments, the individually addressable reference samples used in the compositions for assessing the performance of instruments adapted to track single molecules are selected from: reference samples comprising a plurality of spatially-stationary optical, e.g., fluorescent, point sources; reference samples comprising a plurality of diffusible optical, e.g., fluorescent, point sources; reference samples comprising a homogenous optical, e.g., fluorescent, volume; and reference samples comprising a plurality absorptive or reflective patterns.

In certain embodiments, the reference samples used in the compositions of the present disclosure are contained in individually addressable sample chambers of a sample vessel. In certain embodiments, each of such sample chambers comprises: a bottom surface made of optically permissive material; and a vertical wall formed along a perimeter of the bottom surface forming a cavity therewithin bounded by a bottom end that is closed, and a top end that is open.

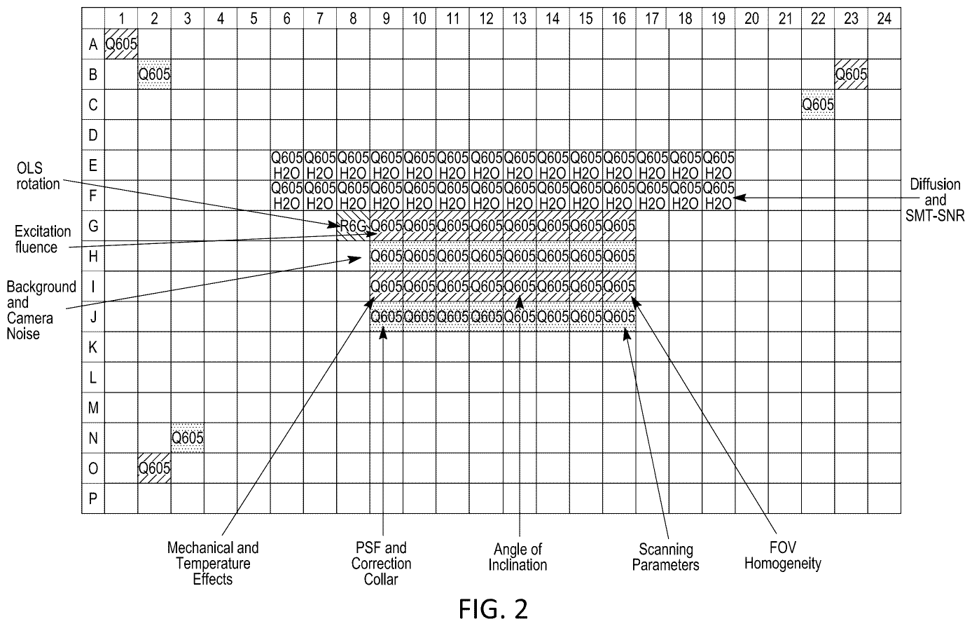

With reference to FIG. 2, aspects of the current subject matter can be implemented using on plates, e.g., tissue culture treated 384-well glass-bottom plates, although other plate types can find use in connection with the approaches outlined herein, including, but not limited to single chambers, 6-well glass-bottom plates, 8-well glass-bottom plates, 9-well glass-bottom plates, 24-well glass-bottom plates, 96-well glass-bottom plates, 1536-well glass-bottom plates, and 3456-well glass bottom plates, as well as plates made of alternative materials, e.g., plates made partially or entirely of plastic. In certain embodiments, such plates will be mated with corresponding lids. In certain embodiments, the lids will be affixed to the plates to avoid loss of the contents contained at one or more well.

In certain embodiments, the sample vessels, e.g., plates, of the present disclosure can be surface treated. In certain embodiments the sample vessel can comprise one or more surface treated sample chamber and one or more non-surface treated chamber. Exemplary surface treatments for use in connection with the sample vessels of the present disclosure include, but are not limited to: ion beam treatment, plasma treatment; UV/ozone treatment; surface adsorption of polymeric substrates (e.g., polyethyene glycol (PEG), poly(methyl methacrylate) (PMMA), polydimethysiloxane (PDMS), polystyrene (PS), polyvinylidenedifluoride (PVDF), etc.). Exemplary surface treatments within the scope of the present disclosure include those disclosed in Auld et. al., Microplate Selection and Recommended Practices in High-throughput Screening and Quantitative Biology, (2020) In: Markossian S, Grossman A, Arkin M, et al., editors. Assay Guidance Manual, which is hereby incorporated by reference in its entirety. Such surface treatments can be used, in certain embodiments to prepare, e.g., clean or etch, a surface for use, while in certain embodiments such surface treatments are used to modify, e.g., attach chemical functional groups and or biomolecules, a surface for use.

### 2.1.1. Reference Samples Comprising Spatially-Stationary Optical Point Sources

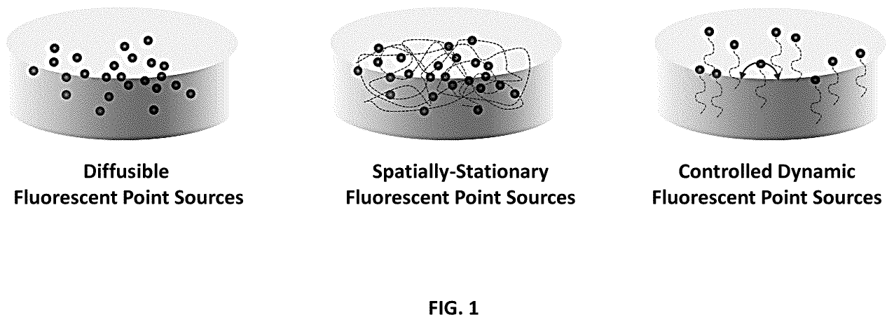

In certain embodiments, and as illustrated in FIG. 1, the present disclosure is directed to compositions comprising a plurality of individually addressable reference samples comprising a plurality of spatially-stationary optical, e.g., fluorescent, point sources, wherein the plurality of spatially-stationary optical, e.g., fluorescent, point sources are immobilized in a polymer. In certain of embodiments, the polymer in which the plurality of spatially-stationary optical, e.g., fluorescent, point sources are immobilized is a hydrogel. In certain embodiments, the polymer in which the plurality of spatially-stationary optical, e.g., fluorescent, point sources are immobilized is a polysaccharide hydrogel, a polyacrylamide hydrogel, a polyacrylic acid hydrogel, a polymethyl acrylate hydrogel, a polyvinyl alcohol hydrogel, a polyvinylpyrrolidone hydrogel, a polyethylene glycol hydrogel, an agarose hydrogel, a gelatin hydrogel, a collagen hydrogel, an alginate hydrogel, or a combination thereof. In certain embodiments, the polymer in which the plurality of spatially-stationary optical, e.g., fluorescent, point sources are immobilized is a polystyrene, an epoxy, a polyvinyl acetate, an ethylene vinyl acetate, a polyurethane, a polytetrafluoroethylene, a polycarbonate, or a polyvinyl butyral. In certain embodiments, the polymer in which the plurality of spatially-stationary optical, e.g., fluorescent, point sources are immobilized is degassed, or homogenized and degassed.

In certain embodiments, the present disclosure is directed to compositions comprising a plurality of individually addressable reference samples comprising a plurality of spatially-stationary optical, e.g., fluorescent, point sources, wherein the optical, e.g., fluorescent, point sources are immobilized in the polymer by covalent conjugation, adsorption, electrostatic binding, or a combination thereof. In certain embodiments, the polymer in which the plurality of spatially-stationary optical, e.g., fluorescent, point sources are immobilized comprises a 3-dimensional lattice.

In certain embodiments of the present disclosure, the plurality of spatially-stationary fluorescent point sources comprise quantum dots. Exemplary quantum dots known in the art and are commercially available exhibiting emission maximums useful in connection with the subject matter disclosed herein. In certain embodiments, the quantum dots have an emission maximum from about 400 nm to about 720 nm. In certain embodiments, the quantum dots have an emission maximum from about 420 nm to about 480 nm. In certain embodiments, the quantum dots have an emission maximum of 450 nm. In certain embodiments, the quantum dots have an emission maximum from about 500 nm to about 550 nm. In certain embodiments, the quantum dots have an emission maximum of 525 nm. In certain embodiments, the quantum dots have an emission maximum of 545 nm. In certain embodiments, the quantum dots have an emission maximum from about 525 nm to about 575 nm. In certain embodiments, the quantum dots have an emission maximum of 565 nm. In certain embodiments, the quantum dots have an emission maximum from about 575 nm to about 650 nm. In certain embodiments, the quantum dots have an emission maximum of 585 nm. In certain embodiments, the quantum dots have an emission maximum of 605 nm. In certain embodiments, the quantum dots have an emission maximum of 625 nm. In certain embodiments, the quantum dots have an emission maximum from about 650 nm to about 720 nm. In certain embodiments, the quantum dots have an emission maximum of 655 nm. In certain embodiments, the quantum dots have an emission maximum of 705 nm.

In certain embodiments, the plurality of spatially-stationary fluorescent point sources comprise nanodiamonds. In certain embodiments, the nanodiamond spatially-stationary fluorescent point sources have an emission maxima from about 400 nm to about 720 nm. In certain embodiments, the nanodiamond spatially-stationary fluorescent point sources have an emission maxima from about 400 nm to about 500 nm. In certain embodiments, the nanodiamond spatially-stationary fluorescent point sources have an emission maxima of about 415 nm. In certain embodiments, the nanodiamond spatially-stationary fluorescent point sources have an emission maxima from about 500 nm to about 550 nm. In certain embodiments, the nanodiamond spatially-stationary fluorescent point sources have an emission maxima from about 550 nm to about 600 nm. In certain embodiments, the nanodiamond spatially-stationary fluorescent point sources have an emission maxima of 510 nm. In certain embodiments, the nanodiamond spatially-stationary fluorescent point sources have an emission maxima of 575 nm. In certain embodiments, the nanodiamond spatially-stationary fluorescent point sources have an emission maxima from about 600 nm to about 700 nm. In certain embodiments, the nanodiamond spatially-stationary fluorescent point sources have an emission maxima of 638 nm.

### 2.1.2. Reference Samples Comprising Diffusible Optical Point Sources

In certain embodiments, and as illustrated in FIG. 1, the present disclosure is directed to compositions comprising a plurality of individually addressable reference samples comprising a plurality of diffusible optical, e.g., fluorescent, point sources, wherein the diffusible optical, e.g., fluorescent, point sources are disposed within a solution. In certain embodiments, the solution in which the diffusible optical, e.g., fluorescent, point sources are disposed comprises Tris: HCl, DMSO, DMEM, DPBS, or H₂O. In certain embodiments, the H₂O is distilled H₂O or deionized H₂O. In certain embodiments, the solution in which the diffusible optical, e.g., fluorescent, point sources are disposed comprises polytungstate. In certain embodiments, the solution in which the diffusible optical point sources are disposed comprises TWEEN® 20 (Polysorbate 20). In certain embodiments, the solution in which the diffusible optical point sources are disposed comprises Triton X-100® (2-[4-(2,4,4-trimethylpentan-2-yl)phenoxy]ethanol). In certain embodiments, the solution in which the diffusible optical, e.g., fluorescent, point sources are disposed comprises polytungstate.

In certain embodiments, the present disclosure is directed to compositions comprising a plurality of individually addressable reference samples comprising a plurality of diffusible optical, e.g., fluorescent, point sources, wherein the diffusible optical, e.g., fluorescent, point sources each comprise a conjugated compound. In certain embodiments, such conjugation results in controlled dynamic diffusible optical, e.g., fluorescent, point sources. For example, but not by way of limitation, the extent that such controlled dynamic optical, e.g., fluorescent, point sources can diffuse is a function of the nature of the conjugation. In certain embodiments, the compound to which the diffusible optical, e.g., fluorescent, point sources are conjugated is a protein, a polyethylene glycol, a polysaccharide, an oligonucleotide, a polyamine, or a polyaminoacid, or derivatives thereof, and analogs thereof.

In certain embodiments, the compound to which the diffusible optical, e.g., fluorescent, point sources are conjugated is a protein selected from egg albumin, serum albumin, and avidin.

In certain embodiments, the compound to which the diffusible optical, e.g., fluorescent, point sources are conjugated is a polyaminoacid selected from, a polylysine, a polyhistidine, or a polyglutamic acid, a polyaspartic acid, derivatives thereof, and analogs thereof. In certain embodiments, the compound to which the diffusible optical, e.g., fluorescent, point sources are conjugated is a polyethylene glycol, derivatives thereof, and analogs thereof, having a molecular weight from about 200 Da to about 6000 Da.

In certain embodiments of the present disclosure wherein the reference sample comprises a plurality of diffusible optical, e.g., fluorescent, point sources and where the diffusible optical, e.g., fluorescent, point sources each comprise a conjugated compound, the reference sample is contained in an individually addressable chamber and the compounds conjugated to the diffusible optical, e.g., fluorescent, point sources are operably linked to a surface of the chamber that is in contact with the reference sample. In certain embodiments of the present disclosure wherein the reference sample comprises a plurality of diffusible optical, e.g., fluorescent, point sources and where the diffusible optical, e.g., fluorescent, point sources each comprise a conjugated compound, the reference sample is contained in an individually addressable chamber and the compound is conjugated to a surface of the chamber and to the diffusible optical, e.g., fluorescent, point source. In certain embodiments of the present disclosure wherein the reference sample comprises a plurality of diffusible optical, e.g., fluorescent, point sources and where the diffusible optical, e.g., fluorescent, point sources each comprise a conjugated compound, wherein the compound is conjugated to a surface of the chamber and to the diffusible optical, e.g., fluorescent, point source, the compound is conjugated on a first end to the bottom surface of the sample chamber, and on a second end to the diffusible optical, e.g., fluorescent, point source. In certain embodiments, such conjugation results in a controlled dynamic optical, e.g., fluorescent, point sources where the diffusion of the optical, e.g., fluorescent, point source is limited to the range of movement imposed by the conjugation of the polymer to the surface. In certain embodiments, the conjugation is by covalent bonding, adsorption, electrostatic bonding, hydrophobic bonding, or a combination thereof.

In certain embodiments, the present disclosure is directed to compositions comprising a plurality of individually addressable reference samples comprising a plurality of diffusible optical, e.g., fluorescent, point sources, wherein the diffusible optical, e.g., fluorescent, point sources are disposed within a polymer. In certain embodiments, the polymer in which the plurality of diffusible optical, e.g., fluorescent, point sources is disposed is a hydrogel. In certain embodiments, the hydrogel in which the plurality of diffusible optical, e.g., fluorescent, point sources is disposed is a polysaccharide hydrogel, a polyacrylamide hydrogel, a polyacrylic acid hydrogel, a polymethyl acrylate hydrogel, a polyvinyl alcohol hydrogel, a polyvinylpyrrolidone hydrogel, a polyethylene glycol hydrogel, an agarose hydrogel, a gelatin hydrogel, a collagen hydrogel, an alginate hydrogel, or a combination thereof. In certain embodiments, the hydrogel in which the plurality of diffusible optical, e.g., fluorescent, point sources is disposed is a polyacrylamide hydrogel, or an agarose hydrogel. In certain embodiments, the hydrogel in which the plurality of diffusible optical, e.g., fluorescent, point sources is disposed is a polystyrene, an epoxy, a polyvinyl acetate, an ethylene vinyl acetate, a polyurethane, a polytetrafluoroethylene (PTFE), a polycarbonate, or a polyvinyl butyral.

In certain embodiments of the present disclosure, the plurality of diffusible fluorescent point sources comprise quantum dots. In certain embodiments, the quantum dots have an emission maximum from about 400 nm to about 720 nm. In certain embodiments, the quantum dots have an emission maximum from about 420 nm to about 480 nm. In certain embodiments, the quantum dots have an emission maximum of 450 nm. In certain embodiments, the quantum dots have an emission maximum from about 500 nm to about 550 nm. In certain embodiments, the quantum dots have an emission maximum of 525 nm. In certain embodiments, the quantum dots have an emission maximum of 545 nm. In certain embodiments, the quantum dots have an emission maximum from about 525 nm to about 575 nm. In certain embodiments, the quantum dots have an emission maximum of 565 nm. In certain embodiments, the quantum dots have an emission maximum from about 575 nm to about 650 nm. In certain embodiments, the quantum dots have an emission maximum of 585 nm. In certain embodiments, the quantum dots have an emission maximum of 605 nm. In certain embodiments, the quantum dots have an emission maximum of 625 nm. In certain embodiments, the quantum dots have an emission maximum from about 650 nm to about 720 nm. In certain embodiments, the quantum dots have an emission maximum of 655 nm. In certain embodiments, the quantum dots have an emission maximum of 705 nm.

In certain embodiments, the diffusible optical, e.g., fluorescent, point sources comprise nanodiamonds. In certain embodiments, the nanodiamonds have an emission maximum from about 400 nm to about 720 nm. In certain embodiments, the nanodiamonds have an emission maximum from about 400 nm to about 500 nm. In certain embodiments, the nanodiamonds have an emission maximum of about 415 nm. In certain embodiments, the nanodiamonds have an emission maximum from about 500 nm to about 550 nm. In certain embodiments, the nanodiamonds have an emission maximum of 510 nm. In certain embodiments, the nanodiamonds have an emission maximum from about 550 nm to about 600 nm. In certain embodiments, the nanodiamonds have an emission maximum of 575 nm. In certain embodiments, the nanodiamonds have an emission maximum from about 600 nm to about 700 nm. In certain embodiments, the nanodiamonds have an emission maximum of 638 nm.

### 2.1.3. Reference Samples Comprising Homogenous Optical Volumes

In certain embodiments, the present disclosure is directed to compositions comprising a plurality of individually addressable reference samples comprising homogenous optical, e.g., fluorescent, volumes. For example, but not by way limitation, such homogenous optical, e.g., fluorescent, volumes cam be individually disposed within a matrix. In certain embodiments, the matrix in which the homogenous optical, e.g., fluorescent, volume is disposed is a solution or a polymer. In certain embodiments, the matrix in which the homogenous optical, e.g., fluorescent, volume is disposed is a solution that comprises Tris: HCl, DMSO, DMEM, DPBS, or H₂O. In some embodiments the H₂O is distilled H₂O or deionized H₂O. In certain embodiments, the polymer matrix in which the homogenous optical, e.g., fluorescent, volume is disposed is a sol-gel, a gel, or a solid. In certain embodiments, the polymer matrix in which the homogenous optical, e.g., fluorescent, volume is disposed is a is a hydrogel. In certain embodiments, the hydrogel matrix in which the homogenous optical, e.g., fluorescent, volume is disposed is a polysaccharide hydrogel, a polyacrylamide hydrogel, a polyacrylic acid hydrogel, a polymethyl acrylate hydrogel, a polyvinyl alcohol hydrogel, a polyvinylpyrrolidone hydrogel, a polyethylene glycol hydrogel, an agarose hydrogel, a gelatin hydrogel, a collagen hydrogel, an alginate hydrogel, or a combination thereof. In certain embodiments, the polymer matrix in which the homogenous optical, e.g., fluorescent, volume is disposed is a polystyrene, an epoxy, a polyvinyl acetate, an ethylene vinyl acetate, a polyurethane, a polytetrafluoroethylene (PTFE), a polycarbonate, or a polyvinyl butyral.

In certain embodiments, the homogenous optical, e.g., fluorescent, volume comprises a fluorescent molecule. Non-limiting examples of such fluorescent molecules include, Fluorescein, Rhodamine 6G (R6G) and Rhodamine B. In some embodiments the fluorescent molecule is a quenched fluorescent molecule. In certain embodiments, the homogenous fluorescent volume comprises a fluorescent molecule having an emission maximum from about 400 nm to about 720 nm. In certain embodiments, the homogenous fluorescent volume comprises a fluorescent molecule having an emission maximum from about 420 nm to about 480 nm. In certain embodiments, the homogenous fluorescent volume comprises a fluorescent molecule having an emission maximum of 450 nm. In certain embodiments, the homogenous fluorescent volume comprises a fluorescent molecule having an emission maximum from about 500 nm to about 550 nm. For example, in certain embodiments, the homogenous fluorescent volume comprises Fluorescein as the fluorescent molecule having an emission maximum of 517 nm. In certain embodiments, the homogenous fluorescent volume comprises a fluorescent molecule having an emission maximum from about 525 nm to about 575 nm. For example, in certain embodiments, the homogenous fluorescent volume comprises Rhodamine B as the fluorescent molecule having an emission maximum of 550 nm. In certain embodiments, the homogenous fluorescent volume comprises a fluorescent molecule having an emission maximum from about 575 nm to about 650 nm. In certain embodiments, the homogenous fluorescent volume comprises a fluorescent molecule having an emission maximum from about 650 nm to about 720 nm.

### 2.1.4. Reference Samples Comprising Resolution Test Patterns

In certain embodiments, the present disclosure is directed to compositions comprising a plurality of individually addressable reference samples comprising one or more resolution test patterns. For example, but not by way of limitation, such resolution test patterns can be absorptive or reflective. Exemplary resolution test patterns known in the art include, but are not limited to, the following patterns: the USAF 1951 resolution test chart; the NBS 1952resolution test chart; the Ronchi ruling target; and the Sector Star target.

### 2.2 Assessing Performance of Instruments Adapted for Single Molecule Tracking

### 2.2.1 Calibration of Instruments Adapted for Single Molecule Tracking

In certain embodiments, the present disclosure is directed to methods of assessing a plurality of performance characteristics of instruments adapted to track single molecules using a composition comprising a plurality of individually addressable reference samples. In certain embodiments, the individually addressable reference samples used in the compositions for assessing the performance of instruments adapted to track single molecules are selected from:
reference samples comprising a plurality of spatially-stationary optical, e.g., fluorescent, point sources;
reference samples comprising a plurality of diffusible optical, e.g., fluorescent, point sources;
reference samples comprising a homogenous optical, e.g., fluorescent, volume; and
reference samples comprising one or more resolution test patterns.

In certain embodiments of such methods, the instrument is a microscope. In certain embodiments, such methods comprise: aligning the objective lens of the microscope to one of the plurality of individually addressable reference samples, wherein the vertical axis of the objective is perpendicular to the horizontal axis of the sample; and
analyzing one or more imaging parameters based on the image captured by the microscope;
analyzing one or more acquisition parameters based on the image captured by the microscope;
analyzing one or more SMT analysis parameters based on the image captured by the microscope; or
a combination thereof.

In certain embodiments, the imaging parameters analyzed in connection with the methods disclosed herein comprise laser parameters, alignment parameters, camera parameters, detection parameters, and combinations thereof. For example, but not by way of limitation, analysis of laser parameters can comprise analyzing one or more of a laser wavelength, a laser pulse, a laser power, a laser intensity, and a laser pulse duration. In certain embodiments, analysis of alignment parameters can comprise analyzing one or both of light-sheet characteristics and the focal plane. In certain embodiments, analysis of the light-sheet characteristics can comprise analyzing one or more of: light-sheet thickness; light-sheet uniformity, light-sheet angle of inclination; and intensity density of the light-sheet. In certain embodiments, analysis of camera parameters can comprise analyzing one or more of a noise pattern, a relative spatial alignment, a relative temporal synchronization, an orientation, or a magnification of a camera. In certain embodiments, analysis of detection parameters can comprises analyzing one or more of aberrations, sensitivity, and resolution. In certain embodiments, analysis of aberrations can comprise analyzing one or more of spherical aberrations, chromatic aberrations, coma aberrations, and trefoil aberrations. In certain embodiments, analyzing the focal plane comprises analyzing the position, flatness, orientation relative to the sample and detector, and thickness of the optical focal plane.

In certain embodiments, the acquisition parameters analyzed in connection with the methods disclosed herein can comprise analyzing temporal parameters and/or spatial parameters. In certain embodiments, analysis of temporal parameters can comprise analyzing one or more of framerate, exposure time, number of frames, and channels. In certain embodiments, analysis of spatial parameters can comprise analyzing one or more of a field of view (FOV) size on a detector chip, a FOV position on a detector chip, and a FOV position in a sample.

In certain embodiments, the SMT parameters analyzed in connection with the methods disclosed herein can comprise analyzing single-molecule localization and/or single-molecule tracking. In certain embodiments, analysis of single-molecule localization can comprise analyzing one or more of a localization error, a number of spots, or a signal to noise ratio (SNR). In certain embodiments, analysis of single-molecule tracking can comprise analyzing one or more of a number of tracks, a track length, a jump length, and a mean posterior diffusion coefficient.

In certain embodiments, the performance characteristic analyzed with respect to one or more of the performance parameters described herein is excitation fluence. In certain embodiments, excitation fluence is analyzed by determining the intensity of a fluorescent dye. In certain embodiments, excitation fluence is analyzed by determining the intensity of one or more point sources. In certain embodiments, excitation fluence is analyzed by determining the thickness of light-sheet.

In certain embodiments, the performance characteristic analyzed with respect to one or more of the performance parameters described herein is selected from: illumination module rotation, e.g., OLS rotation; rotation relative to camera; camera clocking; illumination module angle; illumination module fringes, e.g., OLS fringes; and illumination homogeneity, e.g., OLS homogeneity. For example, but not by way of limitation, the relative orientation of one or more resolution test patterns, e.g., a Ronchi grid pattern, can be employed to facilitate the determination of such performance characteristics. In certain embodiments, the resolution test pattern can be aligned to a holder that is itself aligned to the sample holding stage and the camera can be set to visualize the resolution test pattern. The system can then be adjusted, e.g., rotated, to minimize the angle, resulting in the camera being clocked to the sample holding stage. In certain embodiments, the relative orientation of a stationary light sheet (i.e., where the light-sheet is not scanned) can be determined as the fluorescence light (when a fluorescent dye is employed) appears as a line. Then, using the already clocked camera, the illumination module can be rotated to minimize the angle between excitation and detection to clock the illumination module to the camera.

In certain embodiments, the performance characteristic analyzed with respect to one or more of the performance parameters described herein is plate position and level. For example, but not by way of limitation, the systems described herein can employ a Perfect Focus System (PFS) unit (NIKON®) or similar unit capable of sending a near-infrared laser beam into the glass bottom of the sample holding plates, where the back-reflection of that line can be projected onto a position sensitive holder. Such projection facilitates the position of the detection focal plane relative to the surface of the glass bottom of the sample holding plate (e.g., 1 μm into the sample). In certain embodiments, the focus can thereby be locked onto the sample and the objective will follow automatically the height and curvature of the sample holding plate.

In certain embodiments, the performance characteristic analyzed with respect to one or more of the performance parameters described herein is field of view (FOV) homogeneity. In certain embodiments, FOV homogeneity can be determined by monitoring the fluorescence of pure and homogeneous dye solutions. For example, but not by way of limitation, such analysis of pure and homogenous dye solutions allows the characterization of the homogeneity of the illumination module in SMT imaging. In certain embodiments, monitoring SMT parameters, e.g., as described herein, across the FOV allows for the characterization of the homogeneity of single-molecule detection capabilities.

In certain embodiments, the performance characteristic analyzed with respect to one or more of the performance parameters described herein is the angle of inclination. For example, in certain embodiments, a light-sheet can be positioned in the center of a FOV and the light-sheet is sent into a sample comprising a thin layer of point sources attached to the bottom of the well (e.g., Qdot-containing PAA). In such embodiments, the microscope can perform a z-stack, which results in directly monitoring the 3D shape of the light-sheet and subsequent analysis directed to extracting the position of the fluorescence intensity allows for a calculation of the angle of inclination.

In certain embodiments, the performance characteristic analyzed with respect to one or more of the performance parameters described herein is background and/or camera noise. For example, in certain embodiments, recording different types of noise, e.g., with or without a sample and/or with or without lasers, allows for comparisons to determine noise in a test sample. With respect to SNR analysis, this can be accomplished using single-molecule localization algorithms and calculating the SMT parameters.

In certain embodiments, the performance characteristic analyzed with respect to one or more of the performance parameters described herein is mechanical and/or temperature effects. For example, in certain embodiments, longitudinal monitoring of alignment parameters and SMT parameters with or without changes to the system (e.g., mechanical disturbances can lead to a change in the relative orientation of the light-sheet to the camera and would indicate a mechanical instability of certain components, e.g., the camera holder). In certain embodiments, thermal disturbances can be detected as it can lead to an increase in molecular diffusion due to increased Brownian motion or introduction to optical aberrations. In certain embodiments, the performance characteristic analyzed with respect to one or more of the performance parameters described herein is a point spread function (PSF). For example, but not by way of limitation, this can be determined by the imaging of point sources (e.g., single or multiple, which are then combined), either in 2D or 3D, and characterization of the spatial extent, symmetry, and intensity. PSFs are typically then analyzed/evaluated by the Strehl ratio, FWHM, and aberrations (e.g., spherical, coma, trefoil, astigmatism). In certain embodiments, the performance characteristic analyzed with respect to one or more of the performance parameters described herein is a correction collar. For example, but not by way of limitation, correction collar primarily affects spherical aberrations and the correction collar for a given sample and imaging condition can be monitored as a subset of the PSF characterization. In certain embodiments, figures of merit can be, but are not limited to, PSF parameters (e.g., FWHM, symmetry, and intensity) and/or SMT metrics (SNR, and localization error).

In certain embodiments, the performance characteristic analyzed with respect to one or more of the performance parameters described herein is the focal plane. For example, in certain embodiments, the light-sheet is scanned across a sample comprising a thin layer of point sources attached to the bottom of the well (e.g., Qdot-containing PAA). In such embodiments, the microscope can perform a z-stack, which results in directly monitoring the focal plane and subsequent analysis directed to extracting the sharpness of the point sources allows for calculating the position, orientation, and thickness of the focal plane.

In certain embodiments, the performance characteristic analyzed with respect to one or more of the performance parameters described herein is a focal plane. For example, but not by way of limitation, the focal plane position, orientation, and flatness for a given microscope alignment can be monitored as a subset of imaging sharpness. In certain embodiments, figures of merit can be, but are not limited to, Volath (i.e., a focus metric that computes the sum of absolute differences between adjacent pixels to measure image sharpness, capturing edge intensity), Tenengrad (i.e., a gradient-based focus metric that evaluates image sharpness by calculating the magnitude of the gradient using Sobel operators to emphasize high-frequency content), Redondo (i.e., a focus metric that uses a Laplacian-based operator to estimate image sharpness by measuring the spread or width of the image's energy distribution), Variance of Laplace (i.e., a focus metric that quantifies image sharpness by calculating the variance of the Laplacian of the image, emphasizing areas with high contrast or rapid intensity changes), FFTBP (Fast Fourier Transform Band-Pass) (i.e., a frequency-domain focus metric that evaluates image sharpness by analyzing the magnitude of the high-frequency components after applying a band-pass filter to the Fourier-transformed image), or Fourier Ring Correlation (FRC), (i.e., a frequency-domain focus metric that quantifies image sharpness by measuring the correlation of spatial frequencies between two independent images, indicating the level of detail retained across the image). For example, but not by way of limitation, the results of the focal plane characterization can be integrated in a manual or automated manner by a Perfect Focus System (PFS) unit (NIKON®) or similar unit capable of locking onto the surface of the glass bottom of the sample holding plate and facilitating the position of the detection focal plane relative to the surface of the glass bottom of the sample holding plate (e.g., 1 μm into the sample).

### 2.2.2 Integrated Assessment of Instruments Adapted for Single Molecule Tracking

In certain embodiments, the present disclosure is directed to methods of assessing a plurality of performance characteristics of instruments adapted to track single molecules wherein the above-described methods further comprise repeating the aligning and analysis steps for a plurality of the individually addressable reference samples and integrating the analysis performed for the plurality of individually addressable references samples to thereby assess the plurality of microscope performance characteristics. For example, but not by way of limitation, such integration can take the form of the calculation of a composite score based on the assessments of the performance characteristics. In certain embodiments, modifications to the instrument are performed manually in response to the results of the integrated assessment. In certain embodiments, modifications to the instrument are performed automatically in response to the results of the integrated assessment. In certain embodiments, both manual and automatic modifications to the instrument are performed in response to the results of the integrated assessment. In certain embodiments, the performance characteristic analyzed with respect to one or more of the performance parameters that is integrated into the analysis performed for the plurality of individually addressable references samples is selected from: illumination module rotation, e.g., OLS rotation; rotation relative to camera; camera clocking; illumination module angle; illumination module fringes, e.g., OLS fringes; and illumination homogeneity, e.g., OLS homogeneity. For example, but not by way of limitation, the relative orientation of one or more resolution test patterns, e.g., a Ronchi grid pattern, can be employed to facilitate the determination of such performance characteristics. In certain embodiments, the resolution test pattern can be aligned to a holder that is itself aligned to the sample holding stage and the camera can be set to visualize the resolution test pattern. The system can then be adjusted, e.g., rotated, to minimize the angle, resulting in the camera being clocked to the sample holding stage. In certain embodiments, the relative orientation of a stationary light sheet (i.e., where the light-sheet is not scanned) can be determined as the fluorescence light (when a fluorescent dye is employed) appears as a line. Then, using the already clocked camera, the illumination module can be rotated to minimize the angle between excitation and detection to clock the illumination module to the camera.

In certain embodiments, the performance characteristic analyzed with respect to one or more of the performance parameters that is integrated into the analysis performed for the plurality of individually addressable reference samples is plate position and level. For example, but not by way of limitation, the systems described herein can employ a Perfect Focus System (PFS) unit (NIKON®) or similar unit capable of sending a near-infrared laser beam into the glass bottom of the sample holding plates, where the back-reflection of that line can be projected onto a position sensitive holder. Such projection facilitates the position of the detection focal plane relative to the surface of the glass bottom of the sample holding plate (e.g., 1 μm into the sample). In certain embodiments, the focus can thereby be locked onto the sample and the objective will follow automatically the height and curvature of the sample holding plate.

In certain embodiments, the performance characteristic analyzed with respect to one or more of the performance parameters that is integrated into the analysis performed for the plurality of individually addressable references samples is field of view (FOV) homogeneity. In certain embodiments, FOV homogeneity can be determined by monitoring the fluorescence of pure and homogeneous dye solutions. For example, but not by way of limitation, such analysis of pure and homogenous dye solutions allows the characterization of the homogeneity of the illumination module in SMT imaging. In certain embodiments, monitoring SMT parameters, e.g., as described herein, across the FOV allows for the characterization of the homogeneity of single-molecule detection capabilities.

In certain embodiments, the performance characteristic analyzed with respect to one or more of the performance parameters that is integrated into the analysis performed for the plurality of individually addressable reference samples is angle of inclination. For example, in certain embodiments, a light-sheet can be positioned in the center of a FOV and the light-sheet is sent into a sample comprising a thin layer of point sources attached to the bottom of the well (e.g., Qdot-containing PAA). In such embodiments, the microscope can perform a z-stack, which results in directly monitoring the 3D shape of the light-sheet and subsequent analysis directed to extracting the position of the fluorescence intensity allows for a calculation of the angle of inclination.

In certain embodiments, the performance characteristic analyzed with respect to one or more of the performance parameters that is integrated into the analysis performed for the plurality of individually addressable references samples is background and/or camera noise. For example, in certain embodiments, recording different types of noise, e.g., with or without a sample and/or with or without lasers, allows for comparisons to determine noise in a test sample. With respect to SNR analysis, this can be accomplished using single-molecule localization algorithms and calculating the SMT parameters.

In certain embodiments, the performance characteristic analyzed with respect to one or more of the performance parameters that is integrated into the analysis performed for the plurality of individually addressable references samples is mechanical and/or temperature effects. For example, in certain embodiments, longitudinal monitoring of alignment parameters and SMT parameters with or without changes to the system (e.g., mechanical disturbances can lead to a change in the relative orientation of the light-sheet to the camera and would indicate a mechanical instability of certain components, e.g., the camera holder). In certain embodiments, thermal disturbances can be detected as it can lead to an increase in molecular diffusion due to increased Brownian motion or introduction of optical aberrations.

In certain embodiments, the performance characteristic analyzed with respect to one or more of the performance parameters that is integrated into the analysis performed for the plurality of individually addressable references samples is a point spread function (PSF). For example, but not by way of limitation, this can be determined by the imaging of point sources (e.g., single or multiple, which are then combined), either in 2D or 3D, and characterization of the spatial extent, symmetry, and intensity. PSFs are typically then analyzed/evaluated by the Strehl ratio, FWHM, and aberrations (e.g., spherical, coma, trefoil, astigmatism). In certain embodiments, analyzing the focal plane comprises analyzing the position, flatness, orientation relative to the sample and detector, and thickness of the optical focal plane.

In certain embodiments, the performance characteristic analyzed with respect to one or more of the performance parameters that is integrated into the analysis performed for the plurality of individually addressable references samples is a correction collar. For example, but not by way of limitation, correction collar primarily affects spherical aberrations and the correction collar for a given sample and imaging condition can be monitored as a subset of the PSF characterization. In certain embodiments, figures of merit can be, but are not limited to, PSF parameters (e.g., FWHM, symmetry, and intensity) and/or SMT metrics (SNR, and localization error).

In certain embodiments, the performance characteristic analyzed with respect to one or more of the performance parameters described herein is the focal plane. For example, in certain embodiments, the light-sheet is scanned across a sample comprising a thin layer of point sources attached to the bottom of the well (e.g., Qdot-containing PAA). In such embodiments, the microscope can perform a z-stack, which results in directly monitoring the focal plane and subsequent analysis directed to extracting the sharpness of the point sources allows for calculating the position, orientation, and thickness of the focal plane.

In certain embodiments, the performance characteristic analyzed with respect to one or more of the performance parameters that is integrated into the analysis performed for the plurality of individually addressable references samples is a focal plane. For example, but not by way of limitation, the focal plane position, orientation, and flatness for a given microscope alignment can be monitored as a subset of imaging sharpness. In certain embodiments, figures of merit can be, but are not limited to, Volath (i.e., a focus metric that computes the sum of absolute differences between adjacent pixels to measure image sharpness, capturing edge intensity), Tenengrad (i.e., a gradient-based focus metric that evaluates image sharpness by calculating the magnitude of the gradient using Sobel operators to emphasize high-frequency content), Redondo (i.e., a focus metric that uses a Laplacian-based operator to estimate image sharpness by measuring the spread or width of the image's energy distribution), Variance of Laplace (i.e., a focus metric that quantifies image sharpness by calculating the variance of the Laplacian of the image, emphasizing areas with high contrast or rapid intensity changes), FFTBP (Fast Fourier Transform Band-Pass) (i.e., a frequency-domain focus metric that evaluates image sharpness by analyzing the magnitude of the high-frequency components after applying a band-pass filter to the Fourier-transformed image), or Fourier Ring Correlation (FRC), (i.e., a frequency-domain focus metric that quantifies image sharpness by measuring the correlation of spatial frequencies between two independent images, indicating the level of detail retained across the image). For example, but not by way of limitation, the results of the focal plane characterization can be integrated in a manual or automated manner by a Perfect Focus System (PFS) unit (NIKON®) or similar unit capable of locking onto the surface of the glass bottom of the sample holding plate and facilitating the position of the detection focal plane relative to the surface of the glass bottom of the sample holding plate (e.g., 1 μm into the sample).

### 3. Exemplary Single Molecule Tracking Hardware

### 3.1. Image Acquisition Systems

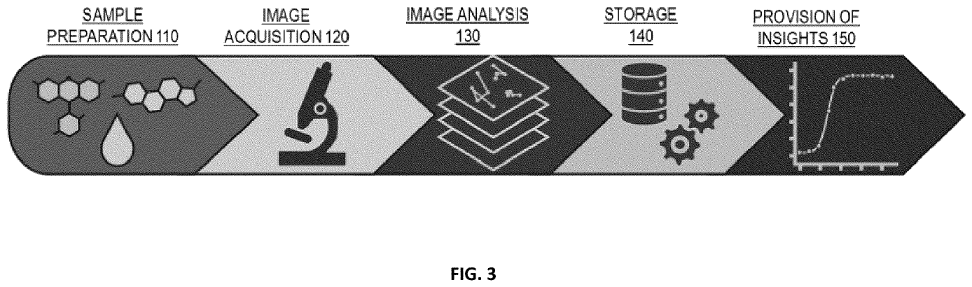

With reference to FIG. 3, aspects of the current subject matter can be implemented using a SMT workflow where such workflow incorporates systems for image acquisition. For example, such image acquisition can incorporate the imaging of samples to generate a series of images and/or videos. In certain embodiments, the exemplary image acquisition system comprises: a light source configured to emit light relayed by one or more optical elements in an optical relay, the optical relay being configured to shape the light emitted from the light source to form a shaped beam such that the shaped beam has a uniform intensity across a longer dimension of the linear shape; an optical element, e.g., a galvo mirror, configured to translate the shaped beam, and which can be position either before or after the optical relay configured to form a shaped beam such that the shaped beam has a uniform intensity across a longer dimension of the linear shape; and one or more optical elements, e.g., a dichroic mirror, configured to direct the shaped beam to an objective, whereby a portion of the sample plane is illuminated by an inclined beam, resulting in the emission of light from the sample, e.g., fluorescence emission, which is focused by the objective, through a series of optical elements, e.g., a lens and an emission filter, to an image collection system.

In certain embodiments, a microscopy system for use performing the methods of the present disclosure can include (a) a stage for supporting a cell-free sample, wherein the cell-free sample comprises a target molecule, e.g., fluorescent molecule, (b) a light source for emitting a light beam capable of inducing a light-based response from the target molecule, e.g., fluorescent molecule, in the cell-free sample, (c) an objective for focusing the light beam on the cell-free sample in the sample plane, wherein the target molecule, e.g., fluorescent molecule, in the sample is disposed in a field of view in the sample plane, (d) a detector device for monitoring the light-based response from the target molecule, e.g., fluorescent molecule, over a period of time (e.g., in the presence of a test molecule), (e) a memory and (f) a processor in communication with the memory and the detector device. In certain embodiments, the processor is capable of determining a diffusion coefficient of the target molecule, e.g., fluorescent molecule, and comparing the diffusion coefficient with a reference diffusion coefficient. In certain embodiments, the processor is capable of determining a diffusion coefficient of the target molecule, e.g., fluorescent molecule, in the presence of a test molecule. In certain embodiments, the reference diffusion coefficient is a diffusion coefficient of the target molecule, e.g., fluorescent molecule, in the absence of the test molecule.

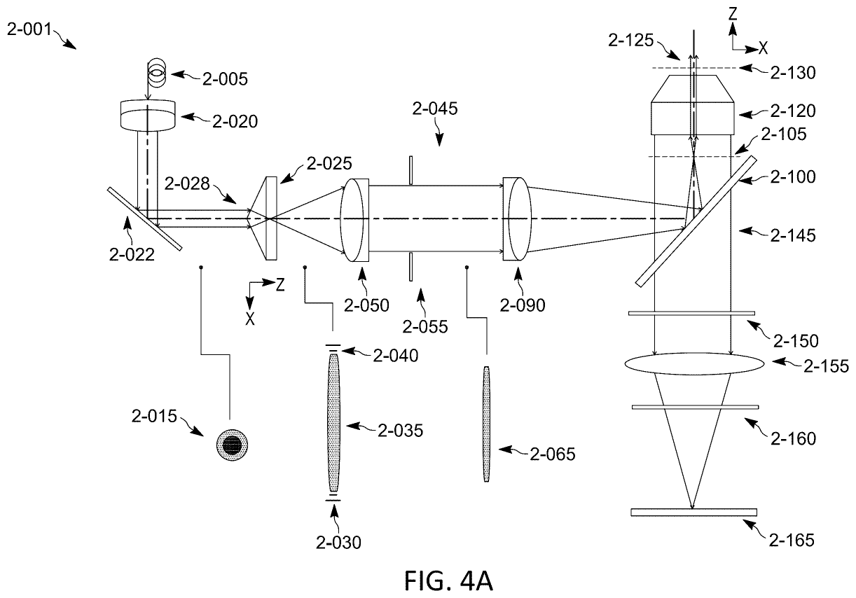

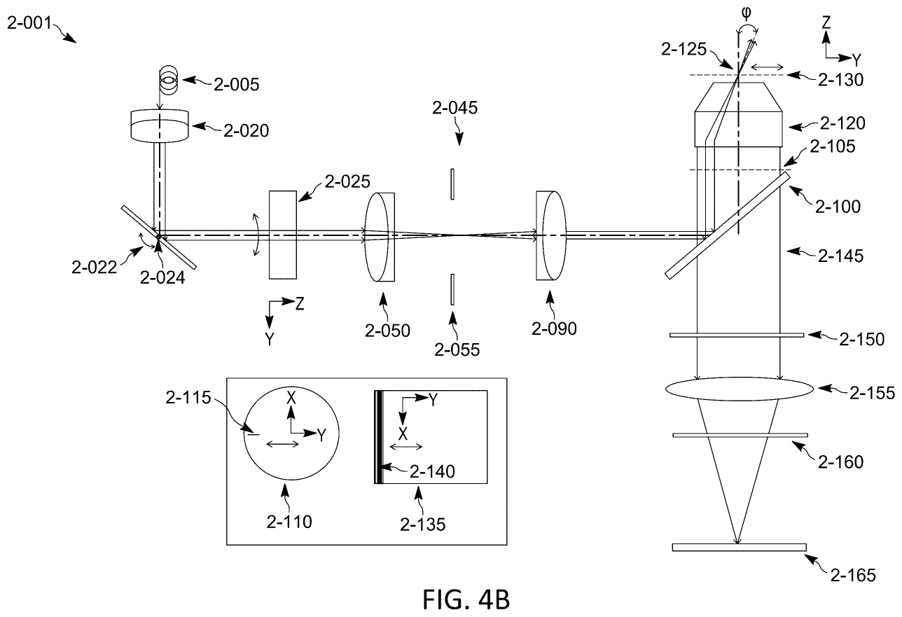

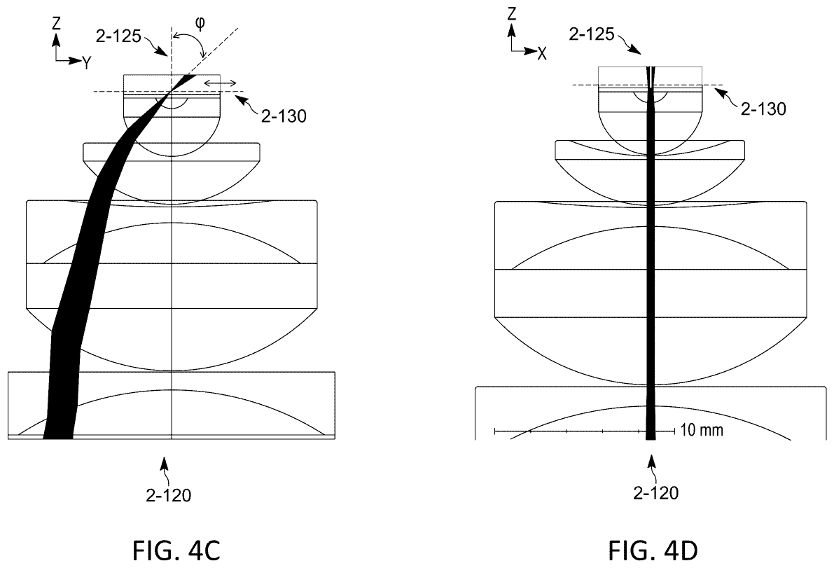

FIG. 4A depicts a schematic of an exemplary image acquisition system of the present disclosure with the X-Z plane visible. FIG. 4B depicts the same exemplary image acquisition system, but with the Y-Z plane visible. In particular embodiments, an exemplary illumination and image acquisition system (2-001) may comprise: a light source (2-005) configured to emit light, a scanning element (2-022), e.g., a galvo mirror, configured to selectively scan the light beam so as to translate the light beam at a sample plane (2-130); an optical forming element (2-025) configured to receive the light beam from the scanning element and produce a light beam having an elongated and linear cross-sectional shape; an optical relay (2-045) configured to direct the light beam to an objective (2-120), whereby a portion of the sample plane (2-130) is illuminated by an inclined beam (2-125), resulting in the emission of light from the sample, e.g., fluorescence emission, which is focused by the objective (2-120), through a series of optical elements, e.g., a tube lens (2-155) and one or more emission filters (2-150, 2-160), to an image collection system (2-165).

### 3.1.1. Light Source

With reference to the exemplary image acquisition system of FIG. 4A, the system comprises a light source (2-005) configured to emit light. The light source (2-005), in certain implementations of the image acquisition systems disclosed herein, can be configured to emit light of a single wavelength. In certain implementations of the image acquisition systems disclosed herein, the light source (2-005) can be configured to emit light of two, three, four, five, or more individual wavelengths. In certain implementations, the wavelength(s) of light emitted by the light source are predetermined. For example, but not by way of limitation, the wavelength(s) can be predetermined such that the emitted light elicits fluorescence emission when illuminating a sample, e.g., a sample comprising a fluorescent protein. In certain instances, the wavelength(s) employed in connection with the methods described herein will fall within a range of 400 nm to 650 nm. In certain instances, the light source (2-005) will emit light having a wavelength between 400 nm to 408, between 550 nm to 565 nm, or between 638 nm to 650 nm. In certain non-limiting implementations, the light source (2-005) is configured to comprise three lasers with nominal central wavelengths 405 nm, 560 nm, 640 nm that could vary within absorption band of the fluorophores used. In certain instances the 405 nm wavelength is used to excite Hoechst dye. In certain instances, a 560 nm wavelength is used to excite dyes (e.g., JF549) attached to HaloTag®. In certain instances, a 640 nm wavelength is used to excite dyes (e.g., Potomac Red).

In certain non-limiting implementations, the light source (2-005) is used to catalyze photochemical reactions. For example, but not by way of limitation, the wavelength(s) and illumination intensities can be such that cleavage of a chemical bond occurs. As an additional example, but not by way of limitation, the wavelength(s) and illumination intensities may induce the adoption of a non-radiative dark state (i.e., “photobleached molecule”). As an additional example, but not by way of limitation, the wavelength(s) and illumination intensities may induce radiative or non-radiative energy transfer between fluorophores within the sample. In certain implementations of the image acquisition systems described herein, the light source (2-005) can be configured to deliver a predetermined amount of power to the back focal plane of the objective (2-105). For example, but not by way of limitation, the light source (2-005) delivers greater than 10 mW with respect to certain wavelengths, e.g., 405 nm, and/or greater than 150 mW with respect to other wavelengths, e.g., 640 nm. Additionally, or alternatively, in instances where the light source (2-005) comprises three lasers emitting at 405 nm, 560 nm, and 640 nm wavelengths, respectively the light source (2-005) can be configured to deliver predetermined amounts of power, to the back focal plane of the objective (2-105). For example, but not by way of limitation the 405 nm can be configured to deliver >10 mW; the 560 nm can be configured to deliver >150 mW; and the 640 nm can be configured to deliver >150 mW). In certain implementations of the image acquisition systems described herein, the light source (2-005) is configured to emit pulsed light. For example, but not by way of limitation, the light source (2-005) can be configured to emit stroboscopic pulsed light. In certain implementations of the image acquisition systems described herein, the light source (2-005) is configured to emit pulsed light in synchrony with the start of image acquisition. In certain, non-limiting implementations, the light source (2-005) will pulse at specific time intervals depending on the number of frames per second being captured. For example, but not by way of limitation, if 100 Frames Per Second (FPS) are being captured by the detector (2-165), the laser is ON for 9 ms and OFF for 1 ms. In contrast, in 200 FPS mode, the laser is ON for 4 ms OFF for 1 ms. In certain implementations of the OLS htSMT workflow, the light source is configured to go from 90% to 10% power in less than about 0.4 ms. In certain implementations of the OLS htSMT workflow, the light source is configured to go from 90% to 10% power in less than about 0.2 ms.

The emission of light by the light source (2-005) and the direction of that light to the image acquisition systems disclosed herein, can, in certain implementations, be facilitated using a single mode fiber. Alternatively, a multimode fiber can be employed in certain implementations of the image acquisition systems disclosed herein. For example, but not by way of limitation, the multimode fiber can be configured with a predetermined shape for sample illumination.

In certain implementations of the image acquisition systems described herein, for example with respect to systems configured for high throughput sample analysis, the light source (2-005) can be configured to exhibit low drift in power output. In certain implementations, such low drift configurations increase sample processing consistency to facilitate high throughout analyses. For example, but not by way of limitation, such low drift power output configurations maintain power output within about 0% to about 15% variation, about 0% to about 10% variation, about 10% variation, about 9% variation, about 8% variation, about 7% variation, about 6% variation, about 5% variation, about 4% variation, about 3% variation, about 2% variation or about 1% variation.

In certain instances, such low drift power output configurations maintain power output within about 0% to about 15% variation, about 0% to about 10% variation, about 10% variation, about 9% variation, about 8% variation, about 7% variation, about 6% variation, about 5% variation, about 4% variation, about 3% variation, about 2% variation or about 1% variation in the context of changing ambient (room) temperature, e.g., 17° C. +/−5° C. In certain instances, this is achieved using temperature sensors and/or close-loop heaters to maintain internal light source (e.g., laser engine) temperatures stable, thereby reducing output power drift. For example, but not by way of limitation, the light source can be thermally insulated from the fluctuations of the ambient temperature using an insulated enclosure design. Additionally, or alternatively, closed-loop heaters can be strategically placed at specific locations in the system, e.g., the fiber coupler to reduce output drift. Additionally, or alternatively, water jackets and/or chillers can be used to reduce heat build-up from the laser heads. Moreover, these thermal controls, used individually or in combination, result in shorter warm up times to reach operating steady state and maintained more stable internal operating temperatures when lasers would be powered off and on.

### 3.1.2. Sample Illumination

In certain embodiments, a system of the present disclosure includes a light source configured to emit light, which is relayed by one or more optical elements in an optical relay, the optical relay being configured to shape the light emitted from the light source to form a shaped beam. The particular optical elements of any particular optical relay implementation can be selected and configured to produce the appropriately shaped beam as well as provide for the appropriate translation of that beam.

In certain, non-limiting, implementations of the optical relay of the presently disclosed image acquisition systems, the optical relay will comprise one or more lenses and/or other optical elements. For example, but not by way of limitation, the selection and orientation of lenses and other optical elements in the optical relay will be configured to appropriately shape the light beam being directed to the sample. In certain non-limiting implementations, the optical relay will comprise optical elements to collimate the emitted light, e.g., a collimator, from the light source. Additionally, or alternatively, the optical relay will comprise additional optical elements, e.g., a Powell lens or other elements adapted to produce a beam fan, one or more cylinder lenses, one or more slits to adjust light sheet extent, one or more achromatic lenses and/or one or more mirrors, one or more of which can be a galvo mirror capable of translating the light. The particular attributes of the optical element will be predetermined to produce an appropriately shaped light beam. For example, but not by way of limitation, the SMT systems of the present disclosure can achieve uniform horizontal FOV as well as uniform vertical FOV. Such uniformity in horizontal and vertical FOVs contrasts with other strategies that provide non-uniform horizontal FOV and/or non-uniform vertical FOV.

To achieve uniform horizontal FOV as well as uniform vertical FOV, the optical relay of the SMT systems described herein comprise an optical element or assembly capable of producing a beam that is elongated along the X plane, and narrow along Y plane and wherein the light beam has a uniform intensity across a longer dimension of the linear shape. In certain non-limiting implementations, the optical relay of the SMT systems described herein will comprise a Powell lens to shape the light beam such that it has a uniform intensity across a longer dimension of the linear shape. The optical relay of the SMT systems described herein can comprise additional or alternative optical elements or assemblies to shape the light beam such that it has a uniform intensity across a longer dimension of the linear shape. For example, but not by way of limitation, the optical relay of the SMT systems described herein can comprise a diffraction element or assembly configured to shape the light beam such that it has a uniform intensity across a longer dimension of the linear shape.

In certain, non-limiting implementations of the optical relays of the presently disclosed image acquisition systems, the optical relay will comprise one or more optical elements or assemblies configured to translate the light beam relative to the sample plane of the sample to be analyzed, e.g., in a direction orthogonal to the longer dimension of the light beam. For example, but not by way of limitation, such optical elements or assemblies configured to translate the light beam relative to the sample plane of the sample to be analyzed can comprise a galvo mirror or a piezo element configured to translate the light beam. Additionally, or alternatively, such optical elements or assemblies configured to translate the light beam relative to the sample plane of the sample to be analyzed can comprise a computer-controlled motor. In certain embodiments, the optical element or assemblies configured to translate the light beam can be positioned before or after optical element or assembly, e.g., a Powell lens, configured to shape the light beam such that it has a uniform intensity across a longer dimension of the linear shape.

In certain embodiments, the system comprises an optical relay configured to shape the light emitted from the light source to form a shaped beam, which is then directed by an optical element, e.g., a dichroic mirror, configured to direct the shaped beam to an objective, whereby the sample plane is illuminated by an inclined beam.

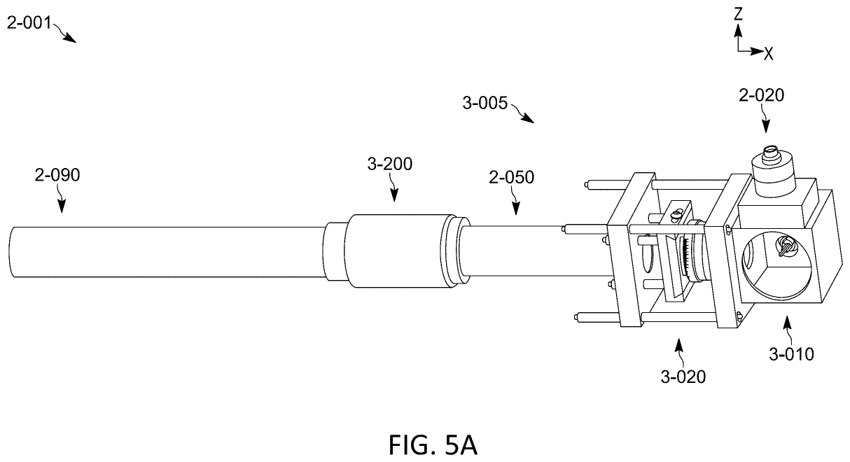

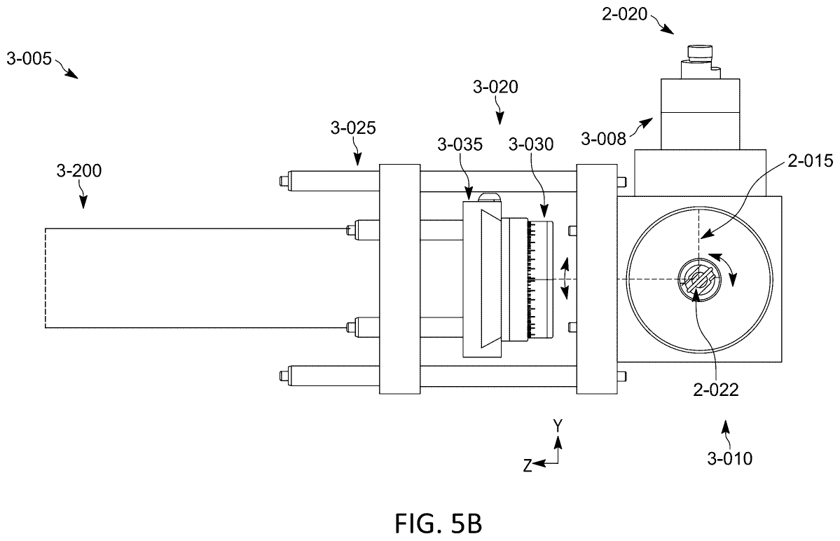

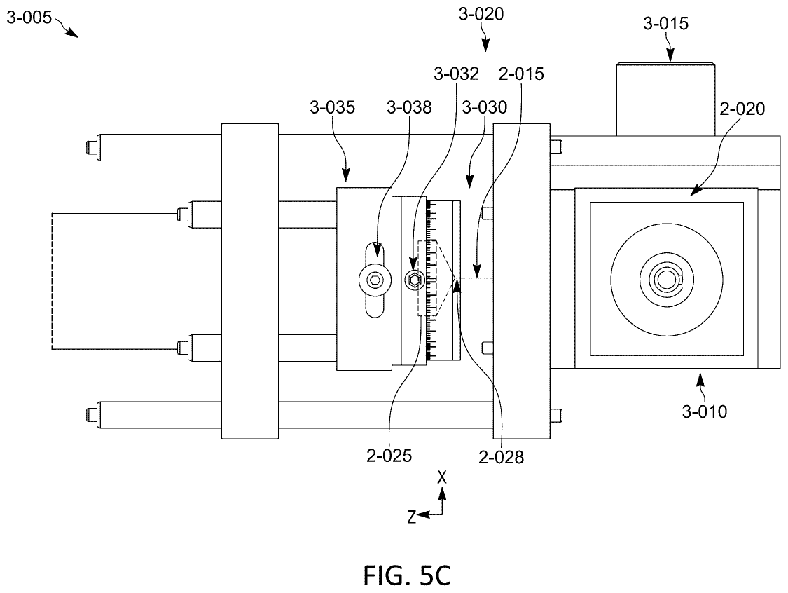

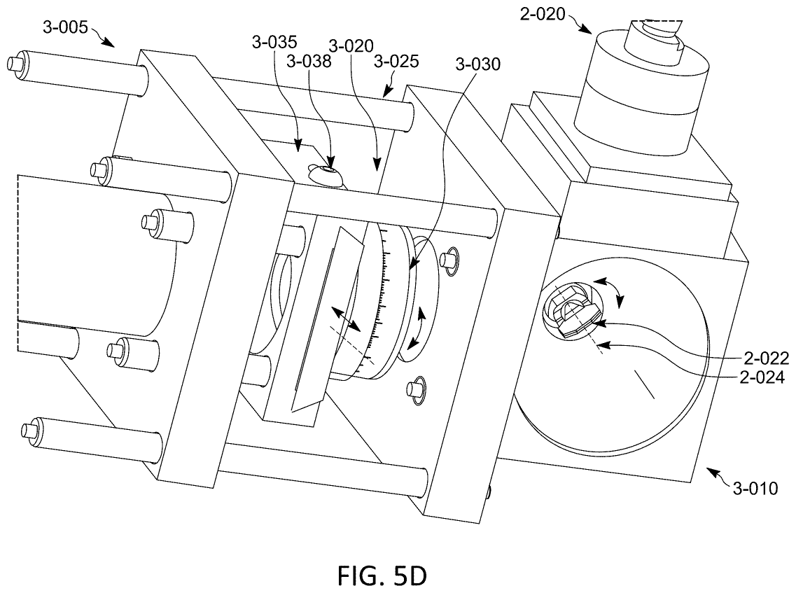

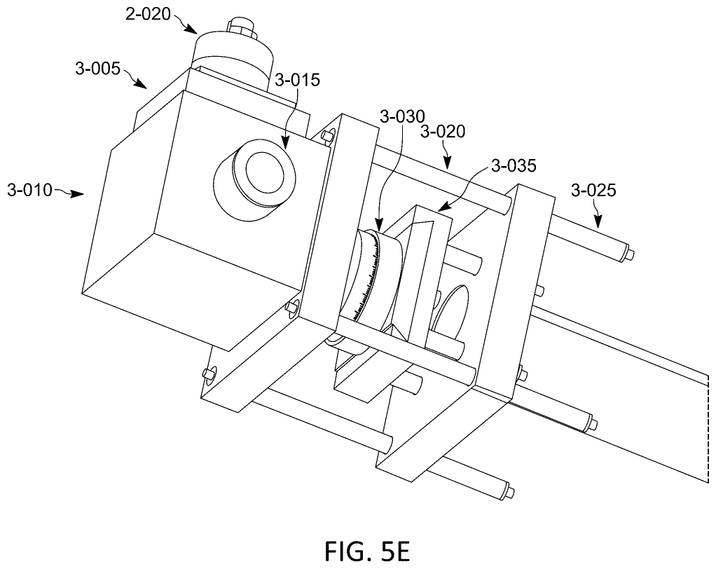

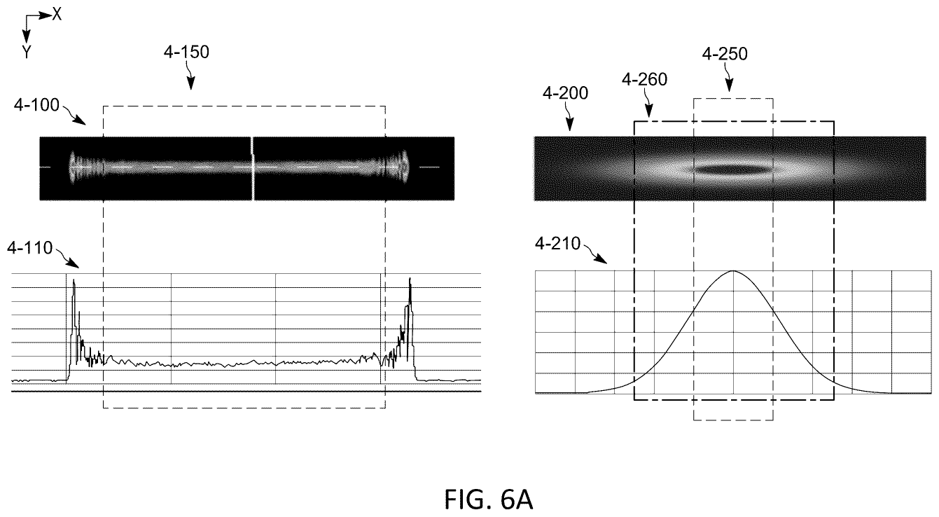

With reference to the exemplary image acquisition system schematically illustrated in FIGS. 4A-4B, the system comprises a light source (2-005) configured to emit light. In particular embodiments, a light source (2-005), such as a fluorescence excitation light source, may provide a light beam to a pre-conditioning optical element or assembly (2-020), which may be configured to provide a collimated light beam to further optical elements and assemblies. The non-limiting example schematically illustrated in FIGS. 4A-4B and FIGS. 5A-5E includes a collimator (2-020).

In particular embodiments, a scanning element (2-022) may be configured to receive a collimated light beam, such as from the pre-conditioning optical assembly (2-020), and selectively scan the received collimated light beam. As non-limiting examples, the scanning element (2-022) may comprise one or more galvo mirrors, one-dimensional galvo mirrors, polygonic mirrors or scanners, micro mirrors, microelectromechanical (MEMS) scanning mirrors, optical modulators, and/or piezo elements. Additionally, or alternatively, such optical elements or assemblies configured to translate the light beam may comprise one or more actuators and/or motors, and may be computer-controlled. In particular embodiments, the collimated light beam may have a Gaussian and/or circular cross-sectional profile immediately following interception by the scanning element (2-022), such as schematically illustrated in FIG. 4A by (2-015) as a non-limiting example. The non-limiting examples schematically illustrated in FIGS. 4A-4B and FIGS. 5A-5E includes a Galvo Mirror (2-022), which is expressly depicted in FIGS. 4A-4B, FIG, 5B, and FIG. 5D.

In certain embodiments, an optical forming element (2-025) may be located to receive the light beam from the scanning element (2-022) and produce a linear light beam, i.e., a light beam having an elongated, line-like, and/or linear cross-sectional shape. As a non-limiting example, a linear beam may be elongated along the X direction, and narrow along Y direction in an X-Y sample plane, such as illustrated in at least FIG. 4B (inset). By way of example and not limitation, the optical forming element (2-025) may comprise one or more of a Powell lens, diffraction optical element(s), optical line generator(s), and/or gradient index of refraction (GRIN) optical element(s). The non-limiting example schematically illustrated in FIGS. 4A-4B and FIGS. 5A-5E includes a Powell lens as the optical forming element (2-025), with an apex (2-028) of Powell lens illustrated in at least FIGS. 4A and 5C.

In particular embodiments, the linear light beam formed by the optical forming element (2-025) may separately or additionally be uniform, i.e., have a uniform intensity across a longer dimension of the elongated and linear shape. In particular embodiments, the linear light beam formed by the optical forming element (2-025) may separately or additionally be collimated along one or more directions. In certain other embodiments, the optical forming element (2-025) may provide a linear beam to, and cooperate with, an optical relay (2-045), such that the combination of (2-025) and (2-045) may produce a collimated and linear beam having an elongated, line-like, and/or linear cross-sectional shape, and having a uniform intensity across a longer dimension of the elongated and linear shape.

In particular embodiments, optical relay (2-045) may be configured to collimate, manipulate, filter, clip, stretch, modulate, modify, reshape, condition, and/or redirect parts or all of the light beam received from the optical forming element (2-025), such as a linear light beam. Separately or additionally, in particular embodiments, optical relay (2-045) may be configured to focus the collimated and linear light beam at the back focal plane (2-105) of an objective (2-120). In certain non-limiting embodiments, optical relay (2-045) may comprise one or more lenses, such as achromatic lenses, doublets, slits, adjustment mechanisms, and/or other optical elements and assemblies suitable for the above disclosed purposes and functions. For example, but not by way of limitation, based on interoperation of at least a scanning element, such as galvo mirror (2-022), an optical forming element (2-025), such as Powell lens, and/or optical relay (2-045), the OLS htSMT systems of the present disclosure can achieve uniform horizontal FOV as well as uniform vertical FOV. Such uniformity in horizontal and vertical FOVs can contrast with other strategies, which can provide non-uniform horizontal FOV and/or non-uniform vertical FOV. In particular embodiments, horizontal uniformity described herein may refer to uniformity of sample illumination light intensity, image light intensity or pixel value, and/or signal-to-noise ratio (SNR). In particular embodiments, vertical uniformity described herein may refer to uniformity of sample illumination light intensity, image light intensity or pixel value, and/or signal-to-noise ratio (SNR).

The non-limiting example schematically illustrated in FIGS. 4A-4B and FIGS. 5A-5E comprises: a scan lens (2-050) configured to collect and/or collimate a light beam received from Powell lens acting as an optical forming element (2-025); a slit (2-055) configured to restrict and/or otherwise filter non-uniform aspects of the received light beam, such as at the edges; and a tube lens (2-090) configured to direct and/or focus the linear light beam at the back focal plane (2-105) of objective (2-120). In particular embodiments, a scan lens (2-050) and/or a tube lens (2-090) may comprise one or more achromatic lenses. By way of further illustration and not limitation, a cross-sectional shape (2-030) of a linear light beam received from a Powell Lens acting as an optical forming element (2-025) may initially comprise particular features, such as a bright core (2-035) and/or edge non-uniformities (2-040). One or more elements of optical relay (2-045) may be configured such that the cross-sectional shape of the linear light beam may be formed as a uniform linear and elongated shape, such as illustrated by shaped beam (2-065).

According to specific embodiments, one or more elements of optical relay (2-045) may focus the linear light beam at the back focal plane (2-105) of an objective (2-120). One or more additional optical elements or assemblies (2-100), such as a dichroic mirror, may be used to selectively route the linear light beam en route to the objective (2-120).

As illustrated by a non-limiting example in FIGS. 4A-4D, objective (2-120) may be configured to incline the light beam at an inclination angle (φ) to the optical axis of the objective (2-120), and to illuminate a sample plane (2-130) by projecting and/or focusing the light beam at the sample plane (2-130). In particular embodiments, an inclination angle (φ) can be provided in a 30°-73° range. In particular embodiments, an inclination angle (φ) can be provided in a range between 55° and 63°, ±10°. In particular embodiments, an inclination angle (φ) can be provided in a range between 57° and 60°, ±5°. In particular embodiments, an inclination angle (φ) can be 53°, 54°, 55°, 56°, 57°, 58°, 59°, 60°, 61°, 62°, or 63°. Separately or additionally, the inclination angle (φ) can be varied or optimized based on sample parameters, stack up tolerances, and/or microscope parameters, including aspects further along the light path than a dichroic mirror in the assembly, or further along than sample illumination. Accordingly, inclination angle (φ) can vary separately or additionally, based on the abovementioned factors, in particular embodiments.

By way of non-limiting example, for highly inclining the linear light beam provided to the objective (2-120), the linear light beam may be introduced to the objective (2-120) such that it is offset from the optical axis of the objective (2-120). As non-limiting examples, the linear light beam may be offset from the optical axis of the objective (2-120) by 3.6 mm to 4 mm in particular embodiments, or by 2.5 mm to 4 mm according to specific embodiments. In certain embodiments, the linear light beam may be offset from the optical axis of the objective (2-120) by 2.5 mm, 2.75 mm, 3 mm, 3.25 mm, 3.5 mm, 3.75 mm, or 4 mm.

Separately or additionally, an offset can be varied or optimized based on stack up tolerances and/or variable microscope parameters, including aspects further along the light path than a dichroic mirror in the assembly, or further along than sample illumination; offsets can further vary accordingly, in particular embodiments.

A view (2-110) of the back focal plane (2-105) is illustrated in FIG. 4B, as seen by a viewer traveling with the illumination light beam and entering objective (2-120), with the appearance of the beam in a cross-section of the back focal plane schematically indicated by (2-115). An illumination view (2-135) of the sample plane (2-130), as seen by a viewer situated on the optical axis of objective (2-120) and receiving the illumination light beam, i.e., looking toward objective (2-120), is also illustrated in FIG. 4B, with (2-140) schematically illustrating the appearance of a linear and uniform light beam at the sample plane.

As has been previously discussed in parts herein, in particular embodiments, a scanning element, such as galvo mirror (2-022), may selectively scan a collimated light beam, such that a linear, uniform light beam (2-140) may correspondingly scan, traverse, or translate in sample plane (2-130). In particular embodiments, such selective scanning by scanning element (2-022) may result in translation of the linear, uniform light beam in sample plane (2-130) along a direction that is orthogonal to the longer dimension of the elongated and linear cross-sectional shape of the beam. As non-limiting examples, particular linear and/or rotational double arrow-head notations in at least FIGS. 4B, 4C, and 5A schematically illustrate a direction of scanning of corresponding optical elements, modules, and/or light beams.

With reference to the non-limiting example illustrated in FIGS. 4A-4D and 5A-5E, selective rotation of galvo mirror (2-022) about a pivoting axle (for e.g., 2-024 in FIGS. 4B and 5D) may enable a collimated light beam (such as 2-015) to be scanned along an apex (2-028) of Powell lens acting as an optical forming element (2-025). In particular embodiments, the collimated light beam received at the apex (2-028) of Powell lens acting as an optical forming element (2-025) may remain collimated following interception and subsequent output from Powell lens acting as an optical forming element (2-025), despite multiple refractions occurring therein. Correspondingly, the linear, uniform light beam at sample plane (2-130) may selectively translate along a direction orthogonal to the longer dimension of the beam. With continuing reference to the non-limiting example illustrated in FIGS. 4A-4D and 5A-5E, the linear, uniform light beam (2-140) in the X-Y sample plane (2-130) formed by the inclined beam (2-125) passing through the sample plane may selectively translate or traverse in the Y-direction based on selective scanning by galvo mirror (2-022), as indicated.

In certain, non-limiting implementations of the image acquisition systems of the present disclosure, objective (2-120) may direct the inclined beam (2-125) on the sample plane (2-130) to be analyzed. In certain, non-limiting implementations of the image acquisition systems of the present disclosure the objective (2-120) may be a water immersion objective. The use of a water immersion objective facilitates high throughput sample analysis by eliminating the oil present in connection with the use of oil immersion objectives, thereby allowing for higher image quality and less distortion. Not only does the presence of oil present issues in the context of automated systems, where the oil can spread to components, including optical elements that can be fouled by exposure to oil, water-immersion objectives are better index-matched for imaging cells, resulting in less distortion and thus higher image quality than with oil objectives. In certain, non-limiting implementations, the objective is a 60X 1.27 NA water immersion objective (Nikon). In certain implementations of the workflows described herein, the water immersion objective (2-120) may be heated by a heating element. For example, such heating element will maintain the water immersion objective (2-120) at a temperature sufficient to avoid inducing a change in temperature of the sample contained in the sample plate (2-021).

### 3.1.3. Opto-Mechanical Design and Assembly

As disclosed for particular embodiments herein, a scanning element (2-022) may be provided in an optical assembly (2-001) to selectively scan a collimated light beam. As may be further observed based on the description provided herein, it is possible to enable the location of scanning element (2-022) prior to, or upstream of, particular additional optical elements that may encountered by a light beam, i.e., before corresponding additional operations or manipulations are performed on the light beam.

For example, based on certain non-limiting examples previously described herein, the scanned collimated beam in particular embodiments, as selectively scanned by the scanning element (2-022), may be subsequently provided to optical forming element (2-025) and/or optical relay (2-045) for additional optical forming, directing, manipulation, and/or other optical operation. As also discussed previously, some example optical operations may include (and are not limited to) shaping a light beam to a linear and elongated cross-section; making a light beam uniform across particular directions, such as the longer dimension of the linear cross-section, collimating a divergent or convergent light beam following another optical operation; directing, routing, or focusing a light beam at one or more particular optical planes of interest.

In certain embodiments, particular optomechanical assemblies, such as referenced and illustrated in FIGS. 5A-5E, can be employed to enable rapid and precise alignment (and re-alignment, such as for maintenance) and/or adjustment of optical elements or assemblies disclosed herein, and to leverage the optomechanical design and approaches employed therein.

As a non-limiting example, certain embodiments of the present disclosure involve scanning or traversing a collimated light beam along an apex (2-028) of a Powell lens acting as an optical forming element (2-025), which can produce a light beam that (a) remains collimated upon exit from the Powell lens acting as an optical forming element (2-025) (as illustrated in FIG. 4B) in a first plane containing the extent of the apex (2-028) and the optical axis of scan lens (2-050), and (b) diverges in an orthogonal plane to the above first plane (as illustrated in FIG. 4A) upon exit from the Powell lens acting as an optical forming element (2-025), and can be subsequently collimated by a suitable optical element or assembly, such as scan lens (2-050), to form a collimated, linear light beam.

In particular embodiments, as illustrated in FIGS. 5A-5E, optical assembly (2-001) may comprise optomechanical subassembly (3-005). In certain non-limiting embodiments, optomechanical subassembly (3-005) may comprise scanning assembly (3-010), an adjustable support mechanism (3-020), and/or an adjustable lens tube (3-200).

In particular embodiments, scanning assembly (3-010) may comprise collimator (2-020), an XY stage (3-008), a galvo mirror (2-022) selectively scannable or rotatable about its pivot axis (2-024), and/or an actuator (3-015) to control galvo mirror (2-022).

In particular embodiments, adjustable support mechanism (3-020) may comprise support rails (3-025), a rotational aligner (3-030), a locking mechanism (3-032) for the rotational aligner, a linear translator (3-035), and/or a locking mechanism (3-038) for the linear translator.

In particular embodiments, one or more optical elements or assemblies may be adjustably supported in, by, and/or within adjustable support mechanism (3-020). As a non-limiting example, Powell lens acting as an optical forming element (2-025) may be adjustably supported within and by adjustable support mechanism (3-020), as illustrated in FIG. 5C.

Linear translator (3-035) may be provided to enable lateral adjustments relative to an optical axis of the assembly, and/or a suitable light beam. In particular embodiments, linear translator (3-035) may be configured to slide, translate, and/or otherwise suitably move relative to an optical axis of the assembly. As a non-limiting example, linear translator (3-035) may be employed to laterally align an apex (2-028) of a Powell lens acting as an optical forming element (2-025) with a received light beam, such as collimated light beam (2-015) received from galvo mirror (2-022).

Rotational aligner (3-030) may be rotationally disposed on adjustable support mechanism (3-020) so as to enable relative rotation of one or more suitable optical elements or assemblies supported therein. As an illustrative and non-limiting example, rotational aligner (3-030) may be employed to rotationally align an apex (2-028) of a Powell lens acting as an optical forming element (2-025) with a scanning direction of a received light beam, such as aligning the scanning direction of a collimated light beam (2-015) received from galvo mirror (2-022) with the extent or length of apex (2-028).

Separately or additionally, in particular embodiments disclosed herein, adjustable support mechanism (3-020) may be used to rapidly and precisely align a scanning direction and plane of collimated light beam (2-015) received from galvo mirror (2-022) with an apex (2-028) of a Powell lens acting as an optical forming element (2-025), such that: (a) a uniform and linear light beam (e.g., 2-140) in a sample plane (2-130) is appropriately aligned with the sample plane (2-130) and/or the field of view (FOV), and/or (b) a selectively activated linear photosensitive segment of a detector device (to be discussed further below, in Image Acquisition) is correspondingly aligned with the uniform and linear light beam in sample plane (2-130), as scanning by a scanning element, such as galvo mirror (2-022), is performed.

In particular embodiments, an adjustable lens tube (3-200) may be employed to support and/or rapidly and precisely align elements or assemblies within optical relay (2-045). As a non-limiting example, adjustable lens tube (3-200) may support and/or provide one or more adjustable mechanisms for scan lens (2-050) and tube lens (2-090).

It will be appreciated that although this disclosure describes particular devices, mechanisms, assemblies, and/or methodologies as non-limiting examples of implementing the aspects disclosed herein, this disclosure contemplates providing any suitable devices, mechanisms, assemblies, and/or methodologies for implementing any such aspects.

FIGS. 5A-5E of the present disclosure, provided at a middle region, a lower region, and an upper region of a sample plane, according to particular embodiments.

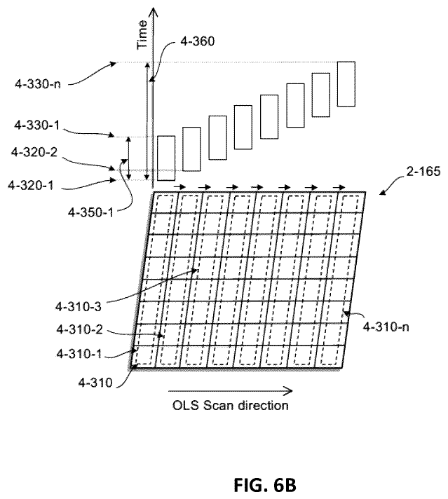

FIG. 6A illustrates cross-sectional features of example light beams for OLS and alternative approaches, according to particular embodiments. In particular embodiments of an OLS system of the present disclosure, a cross-sectional shape of the appearance of a linear light beam of an OLS system of the present disclosure is depicted by (4-100). By way of example and not limitation, in some embodiments, (4-100) may correspond to a cross-sectional shape (2-030) described previously herein. In particular embodiments, a Powell lens acting as an optical forming element (2-025) may be used to generate a cross-sectional shape (4-100). In other embodiments, such as using other forming elements (2-025), (4-100) may differ from the example illustrated in FIG. 6A. A sub-figure (4-110) illustrates an intensity profile of the OLS light beam corresponding to (4-100) along a longer dimension of its cross-sectional shape. In particular embodiments, particular features and/or extent of the OLS light beam cross-section may be clipping, filtered, or otherwise shaped to retain a sub-section (4-150) of the OLS light beam thereafter. As illustrated in FIG. 6A, sub-section (4-150), as depicted in the non-limiting example, may provide a uniform intensity along its longer dimension. Separately or additionally, sub-section (4-150), as illustrated, may be formed of a significant fraction of the total cross-sectional extent and/or light beam energy of the full light beam (4-100). Consequently, sub-section (4-150) of particular OLS embodiments of the present disclosure may provide a combination of a uniform intensity of the OLS light beam, and/or high overall illumination efficiency. As a further consequence, a more efficient and/or compact illumination module may be provided, along with lower heat generation and need for cooling and stabilization.

In contrast to (4-150) and OLS embodiments disclosed herein, alternative methods can employ beam generation and/or shaping techniques that may provide a light beam having a relatively highly non-uniform cross-sectional shape and/or intensity, as illustrated by (4-200). A light intensity profile corresponding to a beam cross-sectional appearance of (4-200) is illustrated by (4-210).

By way of illustration, in such alternative techniques, a desire for a more uniform light beam intensity across a longer dimension of the cross-section may be met by clipping, windowing, filtering, or otherwise extracting a sub-section (4-250) of the overall beam (4-200), such as a narrow central zone thereof. Accordingly, such a sub-section (4-250) can suffer from low overall illumination efficiency based on at least poor utilization of the overall incoming light beam (4-200). Accordingly, larger and heavier illumination modules and assemblies may be required, along with supporting modules for cooling and thermal stabilization of heat generated.

By way of further illustration, in such alternative techniques, a desire for a higher overall light efficiency may motivate clipping, windowing, filtering, or otherwise extracting a sub-section (4-260) of the overall beam (4-200), (4-260) being of a wider section than (4-250). Such an approach may carry at least a disadvantage of a strongly non-uniform light beam along a longer dimension of the cross-section.

Accordingly, as illustrated by the non-limiting examples of FIG. 6A, certain aspects of OLS embodiments disclosed herein provide a means of generating uniform and highly efficient sample illumination simultaneously.

### 3.1.4. Image Acquisition

In certain, non-limiting implementations of the image acquisition systems of the present disclosure, the objective (2-120) may also be used to focus the fluorescence emitted by the sample (2-145) in response to the illumination provided by the inclined beam (2-125). In certain, non-limiting implementations, the objective-focused fluorescence emission (2-145) may pass through an emission filter ((2-150) and/or (2-160)), e.g., a bandpass emission filter matched to the spectrum of the fluorophore under observation and mounted in high-speed filter

wheel (Finger Lakes Instruments), and collected by a detector device (2-165). In certain, non-limiting implementations, the objective-focused fluorescence emission may be directed to an optical tube or relay prior to collection by the detector device (2-165). For example, but not by way of limitation, such an optical tube or relay can comprise one or more lenses (e.g., tube lens 2-155), and one or more additional optical elements, e.g., an element configured to reject additional scattered light, prior to collection by the detector device (2-165). In certain, non-limiting implementations, the objective-focused fluorescence emission is directed through another dichroic mirror to split the emission over multiple regions of the detector (2-165). In certain, non-limiting implementations, the objective-focused fluorescence emission may be directed through another dichroic mirror to split the emission over multiple detectors (2-165).

FIG. 6B illustrates rolling shutter operation, depicting an example of relative timing and synchronization of sensor exposure and sweeping of sample illumination, according to particular embodiments. In certain non-limiting implementations of the image acquisition systems of the present disclosure, the detector device may be configured to synchronize detection and/or activation of photosensitive segments with the translation of the inclined beam (2-125) across the sample plane (2-130). Such synchronization is schematically depicted in FIG. 6B. For example, but not by way of limitation, the detector device can be a CMOS camera, e.g., a back illuminated CMOS camera (the Hamamatsu Fusion BT). In particular embodiments, selective activation of photosensitive segments synchronized with scanning the light beam (2-125) across sample plane (2-130) can provide a confocal effect of selectively filtering out incoming light from out-of-focus planes.

By way of example and not limitation, FIG. 6B illustrates a detector device (2-165), such as a CMOS sensor comprising sensor elements, such as pixels. One or more columns (4-310) of pixels may be activated at a time interval, and provided with imaging light from the illuminated sample plane during that given time. The activated pixels column(s) (4-310) of the sensor may be swept or traversed in time, in synchrony with the scanning or translation of the light beam at the sample plane, which, in turn, may be enabled by synchronously scanning a scanning element (2-022), such as galvo mirror.

By way of non-limiting example, with reference to FIG. 6B, in particular embodiments all pixels of a first column, such as (4-310-1), may be simultaneously exposed by imaging light received from an illuminated section of the sample plane, starting at a time instant (4-320-1) and ending at a time instant (4-330-1), i.e., during a particular column exposure time interval (4-350-1). During the above exposure time interval (4-350-1) of column (4-310-1), other columns of pixels (4-310-2) to (4-310-n) may be deactivated, providing a confocal effect of eliminating background light from other areas of the sample plane which may not be intended for imaging during that exposure time interval (4-350-1).

In a further time instant (4-320-2), which may occur prior to a completion time instant (4-330-1) of exposure of a prior column in particular embodiments, all pixels of a second column, such as (4-310-2), may be simultaneously exposed by imaging light received from the sample plane, wherein the illuminated section of the sample plane may be corresponding swept or scanned by a scanning element, in synchronization with the column activation sweep rate of the sensor. Other columns of pixels may be deactivated during a time interval of exposure of the second column (4-310-2), including one or more priorly activated columns upon completion of their respective exposure time intervals. This process may continue until a last column of pixels of the sensor, such as (4-310-n), may complete the process. Accordingly, a total imaging time interval, such as (4-360) illustrated in FIG. 6B, may be defined for imaging a full FOV.

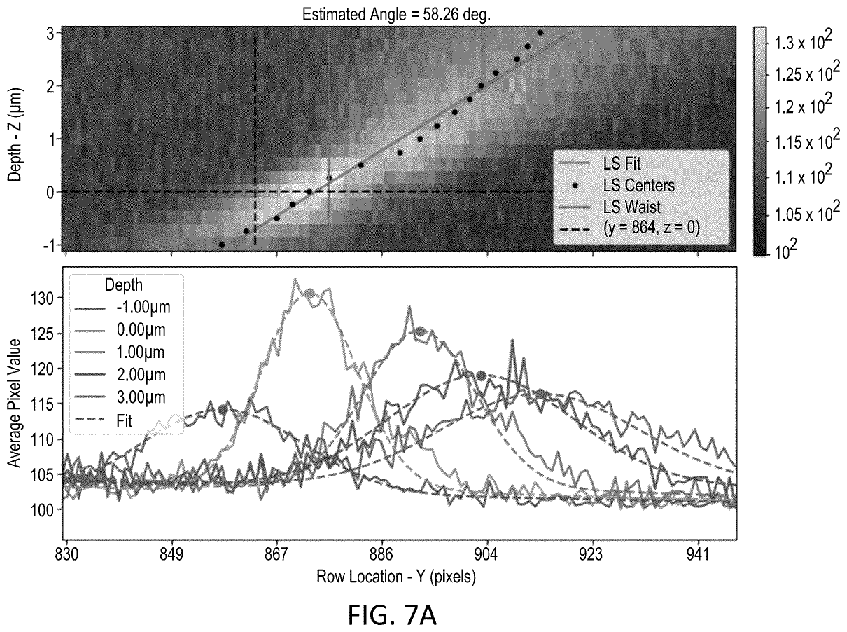

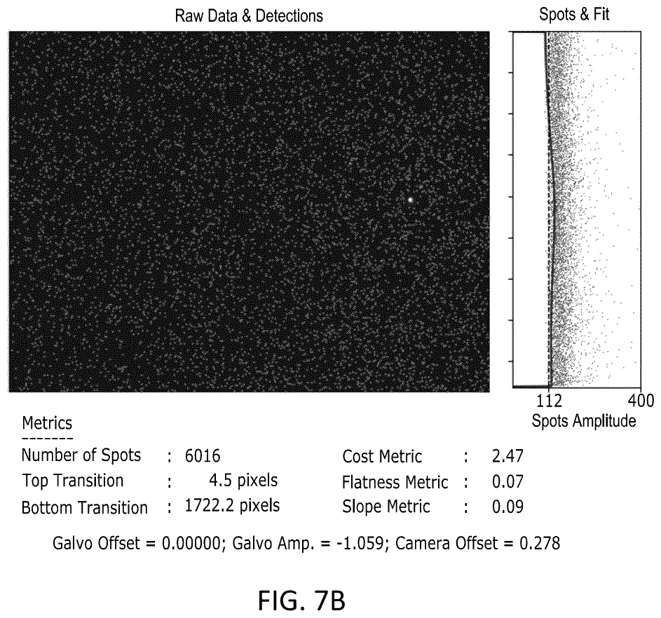

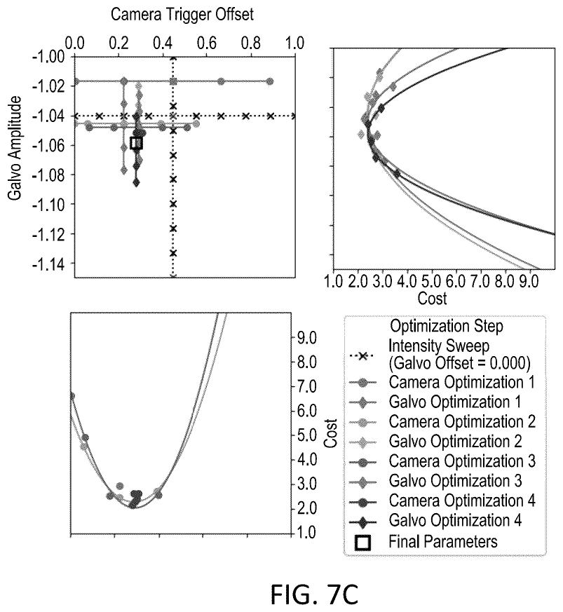

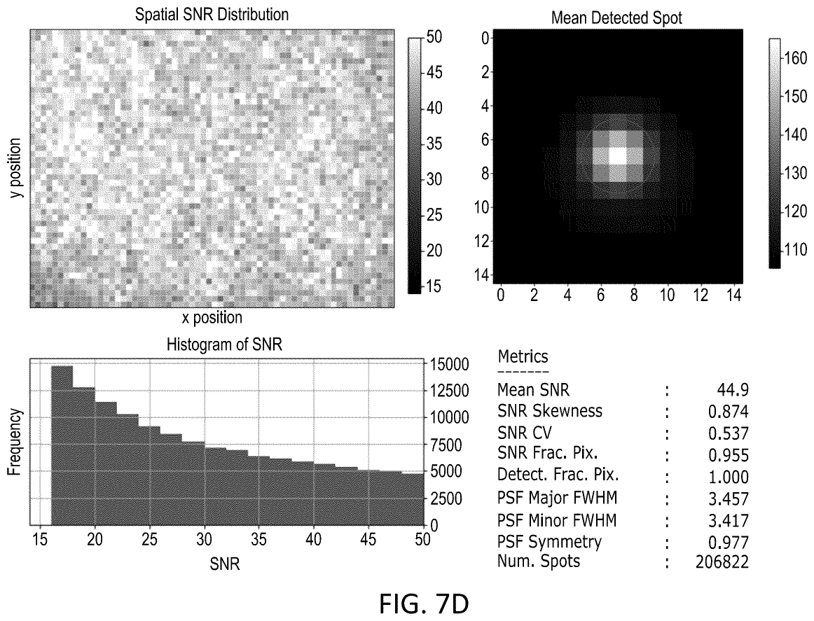

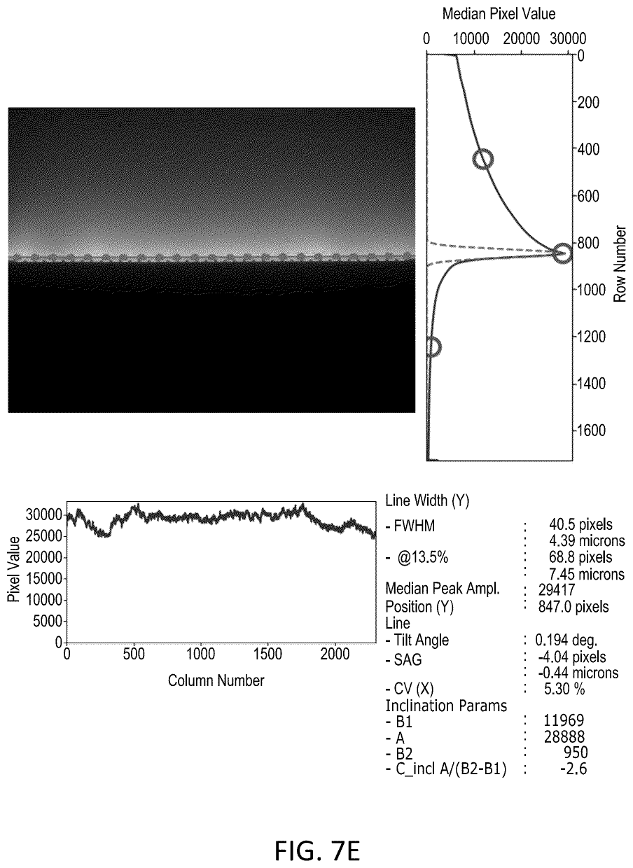

In certain embodiments, the image acquisition systems of the present disclosure are configured to allow for analysis of one or more alignment parameters. FIG. 7A, for example, illustrates results obtained in connection with determining an angle of inclination of an exemplary inclined light-sheet. In certain embodiments of such analysis, for each row of the recorded z-stack Gaussian fitting model statistics provide non-limiting examples of a position of the exemplary inclined light-sheet. A maximum peak amplitude of the light-sheet (expressed in pixel values) provides exemplary metrics of light sheet position perpendicular to the inclination axis at the given position along the z-stack axis. A minimum light-sheet width of the light-sheet (expressed in pixel values) provides exemplary metrics of light sheet waist along the optical beam propagation. A linear fitting model statistics provide non-limiting examples of the inclination angle of an example inclined light-sheet.

FIGS. 7B and 7C provide non-limiting examples of results obtained in connection with a scanning optimization of an exemplary scanned inclined light-sheet. For example, but not by way of limitation, FIG. 7B illustrates spot detection of an exemplary scanned inclined light-sheet of a sample comprising stationary fluorescent point sources. Spot detection statistics, including, but not limited to, number of spots, top transition, and bottom transition, provide exemplary metrics of spatial alignment of an exemplary scanned inclined light-sheet and the camera detection FOV. In certain embodiments, the number of spots, top transition, and bottom transition also provide exemplary metrics of temporal synchronization of an exemplary scanned inclined light-sheet and the camera detection FOV. In certain embodiments, one or more of a flatness metric and a slope metric provide exemplary metrics of FOV homogeneity. Additionally, a cost metric can comprise a composite score based on the assessments of the above-mentioned scanning optimization metrics. Similarly, FIG. 7C illustrates the results of a non-limiting example of an iterative scanning optimization analysis process. In certain embodiments, a camera trigger offset and a galvo amplitude constitute non-limiting parameters that can be analyzed. Again, a cost metric can provide exemplary metrics of scanning optimization with varying scanning parameters in such an iterative context. In certain embodiments, Gaussian fitting model statistics can provide metrics of a scanning optimization analysis process.

FIG. 7D illustrates a non-limiting example of the types of results that can be obtained in a spot detection analysis process. In certain embodiments, spot detection statistics can facilitate scanning optimization. For example, but not by way of limitation, attributes, such as Mean SNR, SNR Skewness, SNR CV, SNR Frac. Pix, and Detect. Frac. Pix. can be used in connection with spot detection of an exemplary scanned inclined light-sheet and be indicative of camera detection FOV homogeneity. Additional characteristics, such as, but not limited to, a PSF Major FWHM, a PSF Minor FWHM, and a PSF Symmetry can perform as metrics of spot detection of an exemplary scanned inclined light-sheet and facilitate analysis of optical aberrations.

FIG. 7E illustrates a non-limiting example of the types of results that can be obtained when aligning an exemplary scanned inclined light-sheet. For example, but not by way of limitation, line width statistics can provide information concerning, e.g., the width of exemplary light beams, including widths measured in a direction perpendicular to a longer dimension of the light beams (Y-width in these illustrations). In addition, a median peak amplitude of the light beam (expressed in pixel value) can provide exemplary metrics of beam intensity. Similarly, a position metric (Y-position, in FIG. 7E) provides numerical references of light beam position corresponding to the corresponding region of each example (Y-position). In certain embodiments, a tilt angle can provide a metric of alignment of each exemplary light beam relative to a horizontal reference of the FOV of the sample plane (i.e., relative to an X-direction). In certain embodiments, a SAG value can provide a numerical metric of sag or curvature of the beam along the longer dimension of the light beam. In certain embodiments, a CV(x) value can provide exemplary metrics of variability of pixel value or intensity along the longer dimension of an exemplary light beam, where CV(x) refers to a coefficient of variation along the longer dimension of the light beam (X-direction), and is defined as a standard deviation of pixel value divided by a mean pixel value of the light beam, taken along the longer dimension of the light beam (X-direction). A non-limiting maximum pixel value corresponding to the examples illustrated in the instant Figures is 65536 (i.e., 2\hat{ }16), well in excess of the peak median pixel value of approximately 30000.

While particular configurations, sequences and/or orientations of illuminating, exposing, sweeping, scanning, and/or sensor activation and deactivation may be provided in this disclosure for illustration, this disclosure contemplates any suitable configuration, sequence, and/or orientation to provide the functions and optical objectives described herein.

In particular embodiments, in addition or alternative to the rolling shutter operation described above, one or more physical slits, pinholes, or equivalent optical elements or assemblies may be used for providing confocality.

In certain implementations of the image acquisition systems of the present disclosure, the CMOS camera can be run such that, for each field of view, a series of SMT frames are collected. For example, but not by w\ay of limitation, 1-20,000 SMT frames, 1-15,000 SMT frames, 1-10,000 SMT frames, 1-5,000 SMT frames, 1-1,000 SMT frames, 2-500 SMT frames, 5-250 SMT frames, 10-200 SMT frames, 100-200 SMT frames, or 200 SMT frames are collected per field of view. In certain implementations, the CMOS camera can be configured to run at a frame rate of from 0.5 to 1000 Hz or in certain implementations, at 100 Hz. For example, but not by way of limitation, certain cellular SMT implementations can be performed at 100 Hz.

In certain, non-limiting implementations of the image acquisition systems of the present disclosure, the detector device is configured to transmit a signal with each frame to trigger other elements of the imaging system. For example, but not by way of limitation, the detector device may trigger the illumination from the light source (2-005) so as to collect fluorescence emission associated with stroboscopic laser pulses. For example, but not by way of limitation, such fluorescence emission collection is associated with 10 to 100 msec frames and a 2 msec stroboscopic laser pulse.

In certain implementations, the imaging acquisition system can be configured to acquire a predetermined image dimension per frame, referred to herein as the Region of Interest (ROI).

In certain implementations, the ROI will differ depending on the frame rate employed. For example, at 100 FPS, 2304×1728 pixels will define the ROI which amounts to 248.832×186.624 microns in the sample plane. In contrast, at 200 FPS, 2304×768 pixels will define the ROI, which amounts to 248.832×82.944 microns in the sample plane.

In certain implementations, the imaging acquisition system can be configured to perform predetermined sweep rates at predetermined frame rates. For example, but not by way of limitation, at 100 FPS: the sweep rate can be 186.624 microns/9 ms, which is equivalent to 20.8 microns/ms, which is equivalent to 2.08 cm/s. In contrast, at 200 FPS the sweep rate can be 82.94 microns/4 ms which is equivalent to 20.7 microns/ms which is equivalent to 2.07 cm/s.

In certain implementations, the detector device can be used to collect fluorescence emission at multiple wavelengths. For example, but not by way of limitation, fluorescence emission of additional fluorophores can be collected at the same frame rate or different frame rates for the same fields of view to provide downstream registration of SMT tracks to other cellular components, e.g., nuclei. Additional channels of the detector device can be used as desired to expand the number of simultaneously captured fluorescence emissions for the same fields of view to provide downstream registration of SMT tracks to other cellular components, e.g., nuclei.

### 4. Exemplary Single Molecule Tracking Software

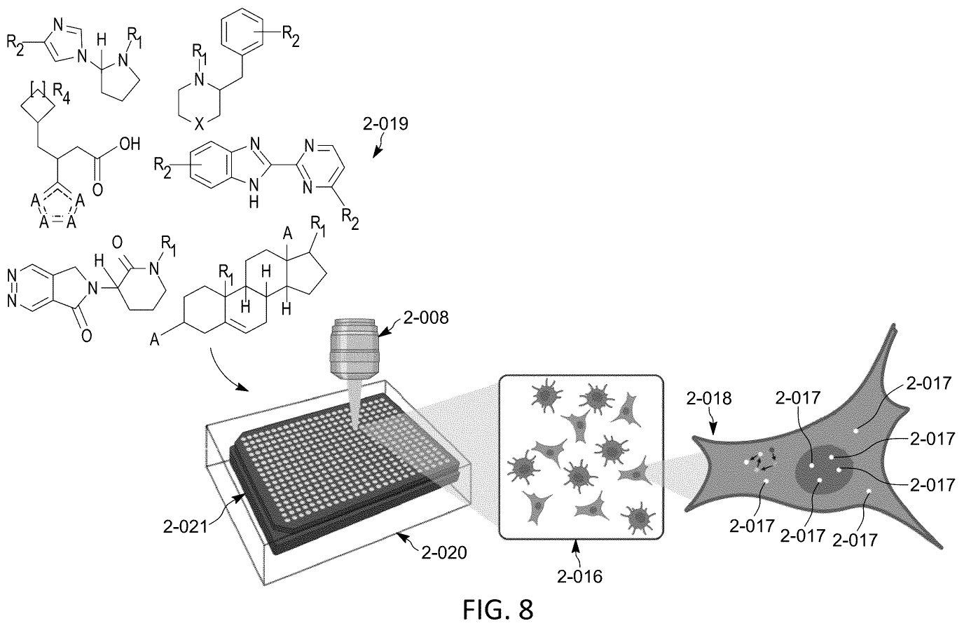

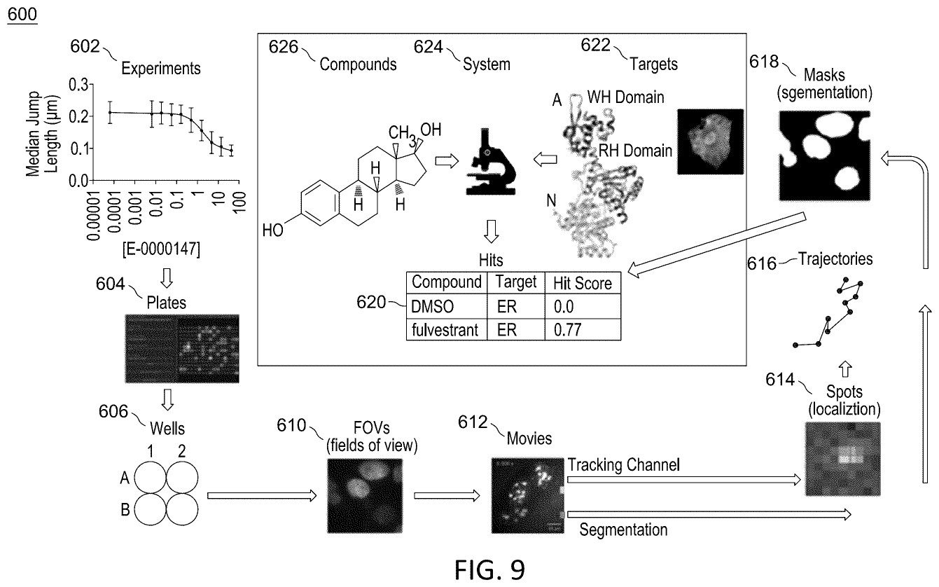

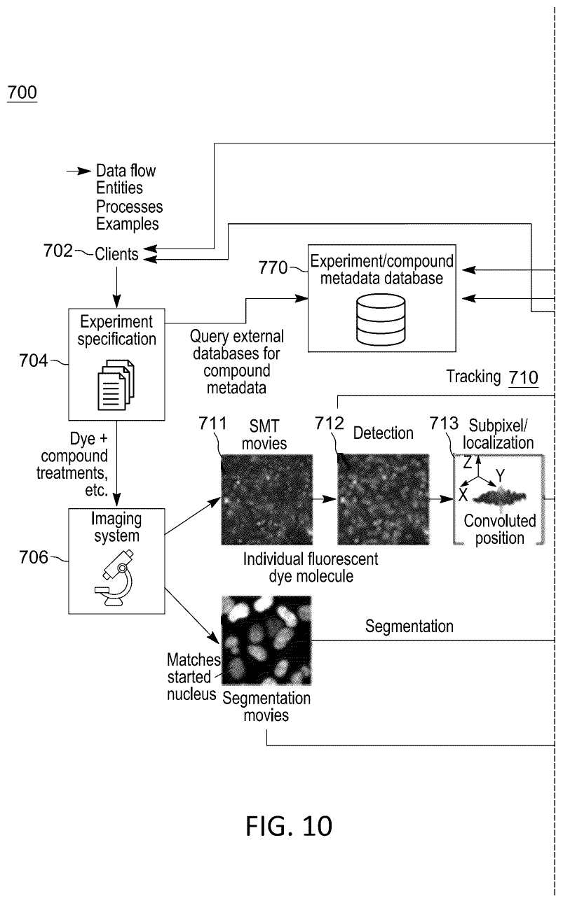

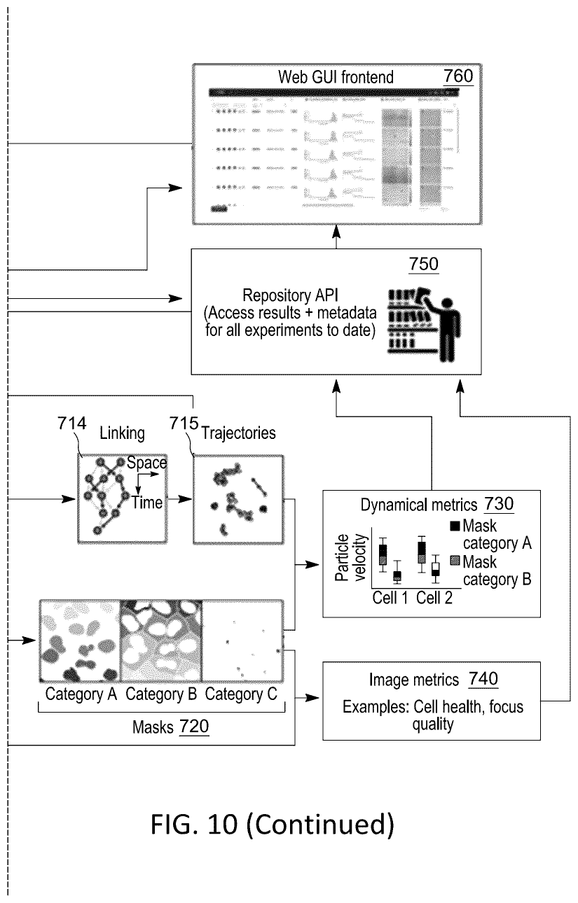

FIG. 8 illustrates an exemplary sample handling system of the present disclosure. FIG. 9 illustrates an example system 600 for a high-throughput single-molecule imaging platform that measures molecule movement, e.g., movement in living cells. Experiments 602 can be performed to collect large amounts of data from a plurality of living cells (e.g., using imaging system 624 to identify compounds 626 and/or targets 622). The experiments 602 can include the application of various identifiers to molecules of interest such as labels which can be subsequently fluoresced or otherwise detected (e.g., using a laser or other light source). The biological samples forming part of such experiments 602 can be organized into plates 604 having a plurality of wells 606. Each well 606 can have one or more associated fields of view (FOVs) 610. FOVs 610 can be locations within or corresponding to a single well 606. A sequence of images can be generated for the FOVs 610 to result in one or more movies 612, which can include SMT movies as well as non-SMT movies. SMT movies can be used to track the paths of individual labeled molecules such as proteins, generating a plurality of trajectories. Each trajectory may be comprised of a plurality of spots 614, which include the spatiotemporal coordinates of a labeled molecule at a particular time (as described in further detail in FIG. 10). Separately from the tracking, and in some instances in parallel with the tracking, the movies 612 can be utilized to identify molecules through the use of machine-learning and/or computer vision-based image segmentation to generate masks 618. Masks 618 are spatial regions within a FOV 610 produced by the segmentation. Each mask 618 can belong to a mask category, which is described in more detail in FIG. 10.

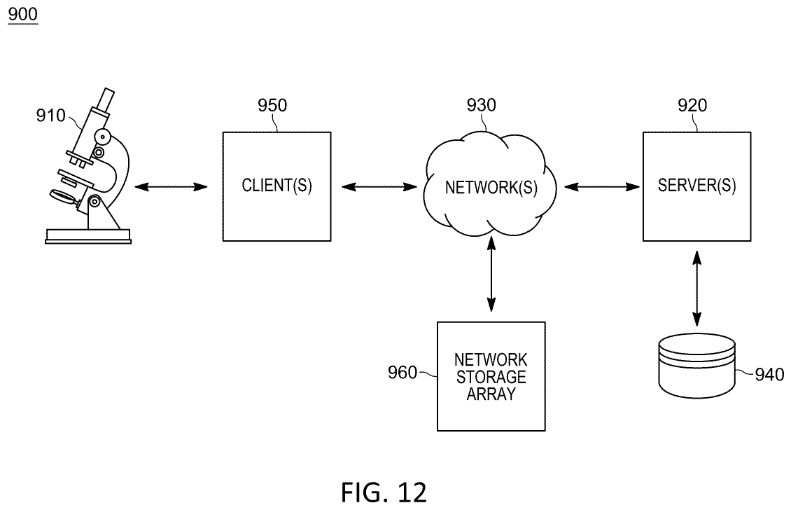

Data associated with two channels (e.g., tracking channel and segmentation/masking channel) can be combined to generate a plurality of metrics 620 associated with various aspects of the samples. In other words, the trajectories 616 (e.g., trajectory data) can be combined with the machine learning processed image segmentation data and further analyzed using statistical / machine learning methods. Processing of the combined data can be used to generate metrics 620 such as hit scores associated with compounds and/or targets within a biological sample that may be stored in a database structure, as further described in FIG. 12.

FIG. 10 illustrates data flow through an example system 700 for a high-throughput single-molecule imaging platform that measures protein movement in living cells. Experiment specifications 704 that define experiments 602 can be provided as data input via one or more clients 702. For example, each experiment 602 can be collected with accompanying stains (e.g., Hoechst or Potomac Red) that are used for downstream analysis including segmentation 618. The experiment specifications 704 can define various parameters for the experiments 602 such as stains, dyes, compounds, treatments, and the like. As previously described in FIG. 9, imaging system 706 (e.g., imaging system 624) can capture a sequence of images that generate one or SMT movies 711 and/or non-SMT movies or segmentation movies 708 (e.g., movies 612) which characterize molecular movement. The SMT movies 711 can characterize movement of individual fluorescent molecules and/or contain images of individual fluorescent molecules. The segmentation movies 708 can comprise a sequence of images that characterize movement of labeled molecules and/or component thereof. It will be appreciated that Hoechst staining is only one technique that can be used to label molecules and that different and/or multiple labeling techniques such as Potomac Red can be utilized depending on the desired configuration. For example, MitoTracker™ Deep Red can be used to label mitochondria), concanavalin A-dye conjugates can be used to label endoplasmic reticulum, SYTO 14 can be used to label nucleoli, phalloidin can be used to label actin, and the like.

The SMT movies 711 can be analyzed to perform operations relating to molecule tracking 710 which can include detecting 712, subpixel localization 713, and linking 714 to identify trajectories 715 of molecules across various images within the SMT movies 711. More specifically, during detection 712 one or more spots within the SMT movies 711 can be detected or recovered. Each spot can be equipped with spatiotemporal coordinates. These spatiotemporal coordinates can be estimated by using subpixel localization techniques 713. Linking 714 can be performed on the spots to ultimately identify trajectories 715.

Links, as used herein, are potential associations between two spots. Each link is directed, beginning at one spot and ending at another. A “correct link” joins two spots produced by the same emitter in different frames; otherwise, a link is “incorrect.” One objective of the linking algorithm is to estimate which links are correct. Links are referred to herein in the format a: i→j This is taken to mean: link α, which begins at spot i and ends at spot j. Links satisfy at least three of the following constraints: (a) links go forward in time, (b) links may not join two spots that are farther apart than some limit (referred to herein as the “search radius”), and (c) links may not join two spots that are temporally separated by more than some limit (referred to herein as the “gap limit”). A spot-link graph is a graph of spots and links for one SMT movie 711. The spots are the vertices and the links are the edges of this graph. Because links go forward in time, the spot-link graph is a directed acyclic graph. A matching is a subset of the links in a spot-link graph such that no two links in this subset begin or end at the same spot. Trajectories 715 are used herein to refer to sequences of contiguous (end-to-end) links in the same matching. Dynamical metrics 730 can be determined using a plurality of trajectories. Such parameters can comprise attributes of a spot that characterize the spot's movement. Such parameters can comprise one or more of velocity, diffusion coefficient, or anomaly parameter(s) for each spot. The dynamical parameter(s) for spot i are herein referred to as θᵢ. The set of dynamical parameters for all spots in a spot-link graph are herein referred to as Θ.

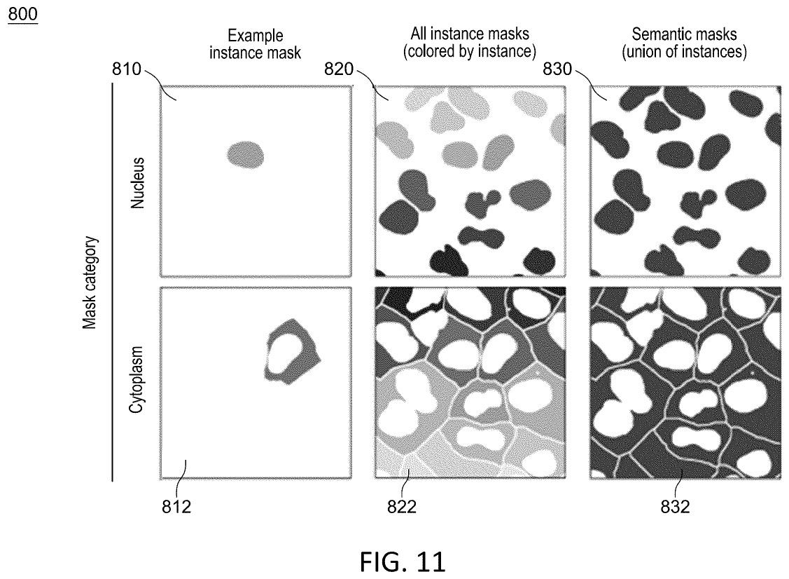

Separate from, and in some variations in parallel with, the processing of SMT movies 711, segmentation movies 708 can undergo segmentation, which generates one or more masks 720. The masks can be of various categories, including but not limited to, cell nuclei, cell cytoplasm, and/or extraneous masks, which are further described in FIG. 11. Instance masks are individual segmented objects (e.g., one cell, one nucleus, one mitochondrion). A FOV 610 may contain any number of instance masks for one mask category. Semantic masks are the union of all instance masks corresponding to one type of mask category for one FOV (e.g., all cells, all nuclei, or all mitochondria for one FOV, etc.). The extraneous masks can contain parts of the non-SMT movie 708 that are excluded from any downstream data analysis. For example, these extraneous masks could correspond to parts of the non-SMT movie 708 that are out of focus or that contain auto fluorescent cell debris that prevents accurate tracking. During segmentation, molecules within the segmentation movies 708 can be assigned to one or more masks. Image metrics 740 can be evaluated from the masked molecules such as cell health, focus quality, or the like.

Experiment information such as the dynamical metrics 730, the image metrics 740, and any data from which either metric is derived (e.g., segmentation information) can be provided to a data repository 770 for storage. Such data repository 770 can store, for example, any results of experiment 602 such as the dynamical metrics 730, image metrics 740, and/or any data from which either metric is derived. Data repository can comprise local persistence and/or dedicated servers accessed locally or by way of the cloud. Data repository 770 can also store metadata associated therewith and/or metadata associated with the experiment specification 704. The experiment information (e.g., results and metadata from historical experiments, etc.) can be provided to data repository 770 via a repository application program interface (API) 750. The repository API 750 can also interface with a web-based graphical user interface front end 760 that provides such information for display on clients 702.

In some variations, segmentation information can be used to identify subcellular compartments such as nuclei, nucleoli, cytoplasm, and the like. Segmentation information can also be used to distinguish one cell from another. Segmentation information can be stored in a specific format (e.g., a multi-image file format such as TIFF, etc.).

Example dynamical metrics 730 can also include state arrays. State arrays are a framework for learning interpretable dynamical models from SMT trajectories, and can be used for gaining additional insight into the movement of a target protein and where in the cell that movement occurs. In some variations, state arrays can be generated / populated using the segmentation information. The outputs for state arrays can be returned at the subcellular compartment level, allowing scientists to distinguish dynamics in different subcellular compartments. Additionally, state arrays can be computed on each individual subcellular compartment (e.g., per nucleus).

To facilitate data access by applications, including but not limited to state arrays, processed SMT data may be stored in a format that permits (a) representation of processed trajectories and associated attributes such as SNR and spot shape characteristics for each SMT movie, (b) representation of mask objects, including mask category (e.g., each mask object's associated subcellular organelle, etc.), (c) association of trajectories with mask objects (such as the cell nucleus in which each trajectory was observed), and (d) association of all SMT movies with metadata relevant to the original experiment, such as compound treatments, acquisition times, and imaging system name. Formats (a) and (c) can be a Protocol Buffer schema defining a storage format for trajectories along with associated mask objects. Format (b) can be a specialized image file format that includes the mask objects to which each pixel in an FOV belongs. Format (d) may be a PostgreSQL database that records all captured experiments/movies. As a client of processed SMT data, state arrays can draw on these data schemas to report dynamic characteristics of trajectories on a per-mask category or per-mask object basis.

FIG. 11 is a plurality of images 800 illustrating differences between mask categories and instance or semantic masks. As previously discussed, non-SMT movies or segmentation movies can be assigned to a plurality of categories. Such categories can include cell nuclei (e.g., Category A), cell cytoplasm (e.g., Category B), and/or extraneous masks (e.g., Category C). Unique, individual masks can be applied to biological samples. For example, image 810 is of a unique, individual instance mask applied to a cell nucleus (e.g., Category A). Image 812 is of a unique, individual instance mask applied to a cell cytoplasm (e.g., Category B). Image 820 illustrates multiple instance masks applied to one or more nuclei, with individual colors representing a different unique, individual instance mask. Image 822 illustrates multiple masks applied to one or more cytoplasms, with individual colors representing a different, unique individual instance mask. Image 830 illustrates a semantic mask, which is the union of all instance masks, applied to one or more nuclei. Image 832 illustrates a semantic mask applied to one or more cytoplasms.

FIG. 12 illustrates an example computer-implemented environment 900 where an imaging system 910 can interact with a computing architecture to perform the various algorithms described herein. As shown in FIG. 12, the imaging system 910 can interface with one or more clients 950 (e.g., clients 702 via a web application having a graphical user interface such). The one or more clients 950 can interface with one or more servers 920 accessible through the network(s) 930. The one or more clients 950 can host a frame grabber that captures images from a camera (e.g., movies 612). Those images can be temporarily stored on the one or more clients 950 and periodically transferred to the one or more servers 920 for remote storage via network 930. The one or more servers 920 can also contain or have access to one or more data stores 940 for storing data collected and/or extracted from a sample by imaging system 910. In some variations, the network 930 may include or interface with one or more network storage arrays 960 for storing data such as the captured images (e.g., movies 612).

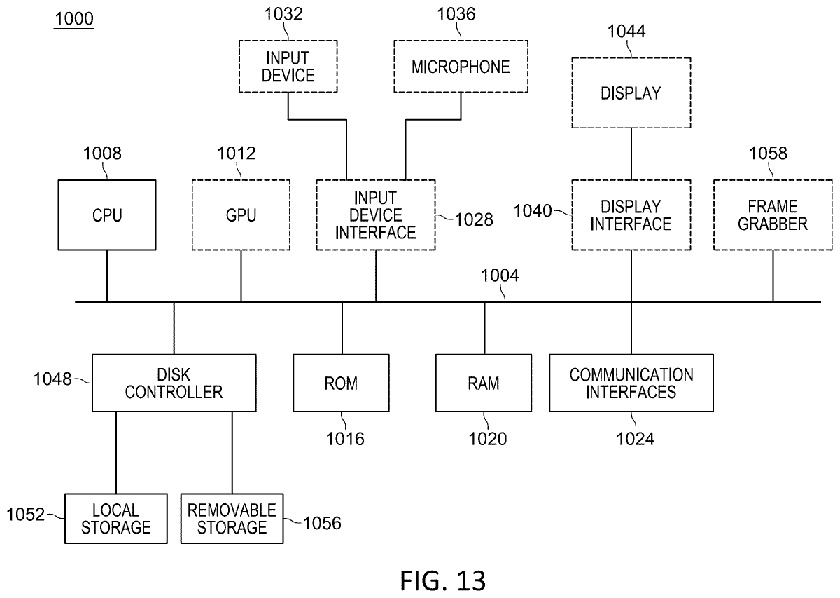

FIG. 13 is a diagram 1000 illustrating a sample computing device architecture for implementing various aspects described herein. In some variations, the sample computing

device architecture can be that of client(s) 950 and/or of server(s) 920 and some components described in relation to diagram 1000 may be optional for the client(s) 950 and/or servers(s) 920. A bus 1004 can serve as the information highway interconnecting the other illustrated components of the hardware. A processing system 1008 labeled CPU (central processing unit) (e.g., one or more computer processors/data processors at a given computer or at multiple computers), can perform calculations and logic operations required to execute a program. Optionally or additionally, a processing system 1012 labeled GPU (graphics processing unit) (e.g., one or more computer processors/data processors at a given computer or at multiple computers), can perform calculations and logic operations required to execute a program. A non-transitory processor-readable storage medium, such as read only memory (ROM) 1016 and random access memory (RAM) 1020, can be in communication with the processing system 1008 and/or processing system 1012 and can include one or more programming instructions for the operations specified here. Optionally, program instructions can be stored on a non-transitory computer-readable storage medium such as a magnetic disk, optical disk, recordable memory device, flash memory, solid state drive or other physical storage medium.

In one example, a disk controller 1048 can interface with one or more optional removable storage 1056 or local storage 1052 to the system bus 1004. The removable storage 1056 can be external or internal disk drives, or solid state drives, or external hard drives. The local storage 1052 can be internal hard drives and/or memory. As indicated previously, these various examples of removable storage 1056, local storage 1052, and disk controllers 1048 are optional devices. The system bus 1004 can also include at least one communications interface 1024 to allow for communication with external devices either physically connected to the computing system or available externally through a wired or wireless network such as cloud storage and remote services. In some cases, the at least one communications interface 1024 includes or otherwise comprises a network interface.

In some variations, such as for client(s) 950, to provide for interaction with a user, the subject matter described herein can be implemented on a computing device having a display device 1044 (e.g., LCD (liquid crystal display) or LED (light-emitting diode) monitor) for displaying information obtained from the bus 1004 via a display interface 1040 to the user and an input device 1032 such as keyboard and/or a pointing device (e.g., a mouse or a trackball) and/or a touchscreen by which the user can provide input to the computer. Other kinds of input devices 1032 can be used to provide for interaction with a user as well; for example, feedback provided to the user can be any form of sensory feedback (e.g., visual feedback, auditory feedback by way of a microphone 1036, or tactile feedback); and input from the user can be received in any form, including acoustic, speech, or tactile input. The input device 1032 and the microphone 1036 can be coupled to and convey information via the bus 1004 by way of an input device interface 1028. By way of example, input device 1032 may be an imaging system 910 configured with abilities to capture a sequence of images as described herein. A frame grabber 1058 can capture or grab individual frames from analog or digital data encapsulating the sequence of images obtained from the bus 1004. Frame grabber 1058 may include memory that can store individual or multiple frames. Frame grabber 1058 can also provide individual or multiple frames to bus 1004 for further storage on, for example, local storage 1052 and/or removable storage 1056. Other computing devices, such as dedicated servers, can omit one or more of the components described in connection with FIG. 13.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

### 5. EXAMPLES

### Exemplary Protocol for Manufacturing a Reference Sample Plate

### 5.1 Exemplary Composition

Qdot-605 stock solution (QDS), 20 μL Qdot 605 probe (ThermoFisher Scientific) in 600 μL distilled water and 3 μL TWEEN 20™.
Qdot-605 diluted solution (QDD). 1 μL QDS in 5 mL distilled water.
QSY™ 9, 0.25% w/v in distilled water.
Rhodamine-6G (R6G), 10 mM in DMSO
Quenched R6G (R6GQ), Mix 25 μL R6G with 25 μL QSY™ 9,
N,N′-Methylenebis(acrylamide) (MBA), 1.53 mg/ml (0.153% w/v) in Tris-HCl (pH 7.5)
Acrylamide, 0.306 g/ml (30.6% w/v) in Tris-HCl (pH 7.5)
Tetramethylethylenediamine (TEMED), Neat
Polyacrylamide stock solution (PAA). Mix 1 mL of the acrylamide solution with 0.09 mL of MBA and 10 μL TEMED just before use.
Ammonium Persulfate (APS) 12.5 mg/ml in Tris-HCl (pH 7.5)
Low Melting-point Agarose, 20 mg/ml in FluoroBrite™ DMEM.
384-well plate.
Bath sonicator.
70° C. shaking heating block.

### 5.2 Exemplary Method

All solutions were sonicated for 30 minutes before use.

### 5.2.1 Polyacrylamide Hydrogel Plating

PAA (300 μL) is mixed with QDS (1 μL), sonicated for 30 minutes, followed by the mixing with APS (50 μL). 50 μL of the mixture is aliquoted into the appropriate wells (e.g., B2, B23, G9-G16, I9-I16, O2, and O23; see FIG. 2) of a 384-well plate such that the mixture is evenly spread and contacts the interior corners of each well.

### 5.2.2 Low Melting Agarose (LMA) Hydrogel Plating

LMA (300 μL) is mixed with QDS (1 μL) in an Eppendorf tube and sonicated for 30 minutes. The tube is heated for 3 minutes at 70° C. at 800 rpm. 50 μL of the heated mixture is aliquoted into the appropriate wells (e.g., C3, C22, H9-H16, J9-J16, N3, and N22; see FIG. 2) of a 384-well plate such that the mixture is evenly spread and contacts the interior corners of each well.

5.2.3 R6G and R6GQ Plating 50 μL of R6G or R6GQ is pipetted into the appropriate wells (e.g., G8 for R6G and H8 for R6GQ, see FIG. 2) of a 384-well plate.

### 5.2.4 Qdot-605 Diluted Solution (QDD) Plating

50 μL of QDD is pipetted into the appropriate wells (e.g., E6-E19, and F6-F19 see FIG. 2) of a 384-well plate.

The 384-well plate is stored overnight at RT without the cover in a dust-free environment before sealing until use.

What is claimed is:

1. A composition comprising a plurality of individually addressable reference samples, wherein the reference samples are selected from:
A. reference samples comprising a plurality of spatially-stationary optical point sources;
B. reference samples comprising a plurality of diffusible optical point sources;
C. reference samples comprising a homogenous optical volume; and
D. reference samples comprising one or more resolution test patterns.

2. The composition of claim 1, wherein the reference samples are contained in individually addressable sample chambers of a sample vessel.

3. The composition of claim 2, where each sample chamber comprises:
A. a bottom surface made of optically permissive material; and
B. a vertical wall formed along a perimeter of the bottom surface forming a cavity therewithin bounded by a bottom end that is closed, and a top end that is open.

4. The composition of claim 1, wherein the plurality of spatially-stationary optical point sources are immobilized in a polymer.

5. The composition of claim 4, wherein the polymer is a hydrogel.

6. The composition of claim 5, wherein the hydrogel is a polysaccharide hydrogel, a polyacrylamide hydrogel, a polyacrylic acid hydrogel, a polymethyl acrylate hydrogel, a polyvinyl alcohol hydrogel, a polyvinylpyrrolidone hydrogel, a polyethylene glycol hydrogel, an agarose hydrogel, a gelatin hydrogel, a collagen hydrogel, an alginate hydrogel, or a combination thereof.

7. The composition of claim 6 wherein the hydrogel is a polyacrylamide hydrogel, or an agarose hydrogel.

8. The composition of claim 4, wherein the polymer is a polystyrene, an epoxy, a polyvinyl acetate, an ethylene vinyl acetate, a polyurethane, a polytetrafluoroethylene, a polycarbonate, or a polyvinyl butyral.

9. The composition of claim 4, wherein the polymer is degassed, or homogenized and degassed.

10. The composition of claim 4, wherein the spatially-stationary optical point sources are immobilized in the polymer by covalent conjugation, adsorption, electrostatic binding, or a combination thereof.

11. The composition of claim 1, wherein the spatially-stationary optical point sources are immobilized within a 3-dimensional lattice formed by the polymer.

12. The composition of any one of claims 1-11, wherein the plurality of spatially-stationary optical point sources is a plurality of spatially-stationary fluorescent point sources.

13. The composition of claim 12, wherein the plurality of spatially-stationary fluorescent point sources comprise quantum dots.

14. The composition of claim 13, wherein the quantum dots have an emission maximum from about 400 nm to about 720 nm.

15. The composition of claim 14, wherein the quantum dots have an emission maximum from about 420 nm to about 480 nm.

16. The composition of claim 15, wherein the quantum dots have an emission maximum of 450 nm.

17. The composition of claim 14, wherein the quantum dots have an emission maximum from about 500 nm to about 550 nm.

18. The composition of claim 17, wherein the quantum dots have an emission maximum of 525 nm.

19. The composition of claim 17, wherein the quantum dots have an emission maximum of 545 nm.

20. The composition of claim 14, wherein the quantum dots have an emission maximum from about 525 nm to about 575 nm.

21. The composition of claim 20, wherein the quantum dots have an emission maximum of 565 nm.

22. The composition of claim 14, wherein the quantum dots have an emission maximum from about 575 nm to about 650 nm.

23. The composition of claim 22, wherein the quantum dots have an emission maximum of 585 nm.

24. The composition of claim 22, wherein the quantum dots have an emission maximum of 605 nm.

25. The composition of claim 22, wherein the quantum dots have an emission maximum of 625 nm.

26. The composition of claim 14, wherein the quantum dots have an emission maximum from about 650 nm to about 720 nm.

27. The composition of claim 26, wherein the quantum dots have an emission maximum of 655 nm.

28. The composition of claim 26, wherein the quantum dots have an emission maximum of 705 nm.

29. The composition of claim 12, wherein the plurality of spatially-stationary fluorescent point sources comprise nanodiamonds.

30. The composition of claim 29, wherein the nanodiamonds have an emission maxima from about 400 nm to about 720 nm.

31. The composition of claim 30, wherein the nanodiamonds have an emission maxima from about 400 nm to about 500 nm.

32. The composition of claim 31, wherein the nanodiamonds have an emission maxima of about 415 nm.

33. The composition of claim 30, wherein the nanodiamonds have an emission maxima from about 500 nm to about 550 nm.

34. The composition of claim 33, wherein the nanodiamonds have an emission maxima of 510 nm.

35. The composition of claim 30, wherein the nanodiamonds have an emission maxima from about 550 nm to about 600 nm.

36. The composition of claim 35, wherein the nanodiamonds have an emission maxima of 575 nm.

37. The composition of claim 30, wherein the nanodiamonds have an emission maxima from about 600 nm to about 700 nm.

38. The composition of claim 37, wherein the nanodiamonds have an emission maxima of 638 nm.

39. The composition of claim 1, wherein the plurality of diffusible optical point sources is disposed within a solution.

40. The composition of claim 39, wherein the solution comprises Tris: HCl, DMSO, DMEM, DPBS, or H₂O.

41. The composition of claim 39, wherein the solution comprises polytungstate.

42. The composition of claim 39, wherein the solution comprises polysorbate 20 or (2-[4-(2,4,4-trimethylpentan-2-yl)phenoxy]ethanol).

43. The composition of claim 1, wherein the diffusible optical point sources each comprise a conjugated compound.

44. The composition of claim 43, wherein the compound is a protein, a polyethylene glycol, a polysaccharide, an oligonucleotide, a polyamine, or a polyaminoacid, or derivatives thereof, and analogs thereof.

45. The composition of claim 43, wherein the compound is a protein selected from egg albumin, serum albumin, and avidin.

46. The composition of claim 43, wherein the compound is a polyaminoacid selected from, a polylysine, a polyhistidine, or a polyglutamic acid, a polyaspartic acid, derivatives thereof, and analogs thereof.

47. The composition of claim 43, wherein the compound is a polyethylene glycol, derivatives thereof, and analogs thereof, having a molecular weight from about 200 Da to about 6000 Da.

48. The composition of claim 43, wherein the plurality of diffusible optical point sources is contained in an individually addressable sample chamber and the compound is operably linked to a surface of the sample chamber.

49. The composition of claim 43, wherein the compound is conjugated to a surface of the sample chamber and to the diffusible optical point source.

50. The composition of claim 49, wherein the compound is conjugated on a first end to the bottom surface of the sample chamber, and on a second end to the diffusible optical point source.

51. The composition of claim 50, wherein the conjugation is by covalent bonding, adsorption, electrostatic bonding, hydrophobic bonding, or a combination thereof.

52. The composition of claim 1, wherein the plurality of diffusible optical point sources is disposed in a polymer.

53. The composition of claim 52, wherein the polymer is a hydrogel.

54. The composition of claim 53, wherein the hydrogel is a polysaccharide hydrogel, a polyacrylamide hydrogel, a polyacrylic acid hydrogel, a polymethyl acrylate hydrogel, a polyvinyl alcohol hydrogel, a polyvinylpyrrolidone hydrogel, a polyethylene glycol hydrogel, an agarose hydrogel, a gelatin hydrogel, a collagen hydrogel, an alginate hydrogel, or a combination thereof.

55. The composition of claim 53 wherein the hydrogel is a polyacrylamide hydrogel, or an agarose hydrogel.

56. The composition of claim 52, wherein the polymer is a polystyrene, an epoxy, a polyvinyl acetate, an ethylene vinyl acetate, a polyurethane, a polytetrafluoroethylene (PTFE), a polycarbonate, or a polyvinyl butyral.

57. The composition of any one of claims 39-56, wherein the plurality of diffusible optical point sources comprise quantum dots.

58. The composition of claim 57, wherein the quantum dots have an emission maximum from about 400 nm to about 720 nm.

59. The composition of claim 58, wherein the quantum dots have an emission maximum from about 420 nm to about 480 nm.

60. The composition of claim 58, wherein the quantum dots have an emission maximum of 450 nm.

61. The composition of claim 58, wherein the quantum dots have an emission maximum from about 500 nm to about 550 nm.

62. The composition of claim 61, wherein the quantum dots have an emission maximum of 525 nm.

63. The composition of claim 61, wherein the quantum dots have an emission maximum of 545 nm.

64. The composition of claim 58, wherein the quantum dots have an emission maximum from about 525 nm to about 575 nm.

65. The composition of claim 64, wherein the quantum dots have an emission maximum of 565 nm.

66. The composition of claim 58, wherein the quantum dots have an emission maximum from about 575 nm to about 650 nm.

67. The composition of claim 66, wherein the quantum dots have an emission maximum of 585 nm.

68. The composition of claim 66, wherein the quantum dots have an emission maximum of 605 nm.

69. The composition of claim 66, wherein the quantum dots have an emission maximum of 625 nm.

70. The composition of claim 58, wherein the quantum dots have an emission maximum from about 650 nm to about 720 nm.

71. The composition of claim 70, wherein the quantum dots have an emission maximum of 655 nm.

72. The composition of claim 70, wherein the quantum dots have an emission maximum of 705 nm.

73. The composition of any one of claims 39-56, wherein the plurality of diffusible optical point sources comprise nanodiamonds.

74. The composition of claim 73, wherein the nanodiamonds have an emission maximum from about 400 nm to about 720 nm.

75. The composition of claim 74, wherein the nanodiamonds have an emission maximum from about 400 nm to about 500 nm.

76. The composition of claim 75, wherein the nanodiamonds have an emission maximum of about 415 nm.

77. The composition of claim 74, wherein the nanodiamonds have an emission maximum from about 500 nm to about 550 nm.

78. The composition of claim 77, wherein the nanodiamonds have an emission maximum of 510 nm.

79. The composition of claim 74, wherein the nanodiamonds have an emission maximum from about 550 nm to about 600 nm.

80. The composition of claim 79, wherein the nanodiamonds have an emission maximum of 575 nm.

81. The composition of claim 74, wherein the nanodiamonds have an emission maximum from about 600 nm to about 700 nm.

82. The composition of claim 81, wherein the nanodiamonds have an emission maximum of 638 nm.

83. The composition of claim 1, wherein the homogenous optical volume is disposed within a matrix.

84. The composition of claim 83, wherein the matrix is a solution, or a polymer.

85. The composition of claim 84, wherein the solution comprises Tris: HCl, DMSO, DMEM, DPBS, or H₂O.

86. The composition of claim 84, wherein the polymer is a sol-gel, a gel, or a solid.

87. The composition of claim 86, wherein the polymer is a hydrogel.

88. The composition of claim 87 wherein the hydrogel is a polysaccharide hydrogel, a polyacrylamide hydrogel, a polyacrylic acid hydrogel, a polymethyl acrylate hydrogel, a polyvinyl alcohol hydrogel, a polyvinylpyrrolidone hydrogel, a polyethylene glycol hydrogel, an agarose hydrogel, a gelatin hydrogel, a collagen hydrogel, an alginate hydrogel, or a combination thereof.

89. The composition of claim 87 wherein the hydrogel is a polyacrylamide hydrogel, or an agarose hydrogel.

90. The composition of claim 84, wherein the polymer is a polystyrene, an epoxy, a polyvinyl acetate, an ethylene vinyl acetate, a polyurethane, a polytetrafluoroethylene (PTFE), a polycarbonate, or a polyvinyl butyral.

91. The composition of claim 83, wherein the homogenous optical volume comprises a fluorescent molecule.

92. The composition of claim 91, wherein the fluorescent molecule has an emission maximum from about 400 nm to about 720 nm.

93. The composition of claim 92, wherein the fluorescent molecule has an emission maximum from about 420 nm to about 480 nm.

94. The composition of claim 93, wherein the fluorescent molecule has an emission maximum of 450 nm.

95. The composition of claim 92, wherein the fluorescent molecule has an emission maximum from about 500 nm to about 550 nm.

96. The composition of claim 95, wherein the fluorescent molecule has an emission maximum of 517 nm.

97. The composition of claim 96, wherein the fluorescent molecule is Fluorescein.

98. The composition of claim 95, wherein the fluorescent molecule has an emission maximum of 525 nm.

99. The composition of claim 95, wherein the fluorescent molecule has an emission maximum of 545 nm.

100. The composition of claim 92, wherein the fluorescent molecule has an emission maximum from about 525 nm to about 575 nm.

101. The composition of claim 95, wherein the fluorescent molecule has an emission maximum of 550 nm.

102. The composition of claim 101, wherein the fluorescent molecule is Rhodamine B.

103. The composition of claim 100, wherein the fluorescent molecule has an emission maximum of 565 nm.

104. The composition of claim 92, wherein the fluorescent molecule has an emission maximum from about 575 nm to about 650 nm.

105. The composition of claim 104, wherein the fluorescent molecule has an emission maximum of 585 nm.

106. The composition of claim 104, wherein the fluorescent molecule has an emission maximum of 605 nm.

107. The composition of claim 104, wherein the fluorescent molecule has an emission maximum of 625 nm.

108. The composition of claim 92, wherein the fluorescent molecule has an emission maximum from about 650 nm to about 720 nm.

109. The composition of claim 108, wherein the fluorescent molecule has an emission maximum of 655 nm.

110. The composition of claim 108, wherein the fluorescent molecule has an emission maximum of 705 nm.

111. The composition of claim 91, wherein the fluorescent molecule is a quenched fluorescent molecule.

112. The composition of claim 1, wherein the one or more resolution test patterns are adapted for evaluating one or more of a resolution test pattern, a field distortion test pattern, or a parfocal stability test pattern.

113. The composition of claim 1, wherein the one or more resolution test patterns are selected from absorptive patterns, reflective patterns, and birefringent patterns.

114. A method of assessing a plurality of performance characteristics of a microscope comprising:
A. aligning the objective lens of the microscope to one of the plurality of individually addressable reference samples of a composition of any one of claims 1-113, wherein the vertical axis of the objective is perpendicular to the horizontal axis of the sample; and
(i). analyzing one or more imaging parameters based on the image captured by the microscope;
(ii). analyzing one or more acquisition parameters based on the image captured by the microscope;
(iii). analyzing one or more single molecule tracking (SMT) analysis parameters based on the image captured by the microscope; or
(iv). a combination of (i)-(iii);
B. repeating the aligning and analyzing steps for a plurality of the individually addressable reference samples; and
C. integrating the analysis performed for the plurality of individually addressable references samples to thereby assess the plurality of microscope performance characteristics.

115. The method of claim 114, wherein the imaging parameters comprise: laser parameters, alignment parameters, camera parameters, or detection parameters, or a combination thereof.

116. The method of claim 115, wherein analyzing the laser parameters comprises analyzing one or more of a laser wavelength, a laser pulse, and a laser pulse duration.

117. The method of claim 115, wherein analyzing the alignment parameters comprises analyzing one or both of a light-sheet characteristics and a focal plane.

118. The method of claim 117, wherein analyzing the light-sheet characteristics comprises analyzing one or more of: light-sheet thickness; light-sheet uniformity, light-sheet angle of inclination; and intensity density of the light-sheet.

119. The method of claim 116, wherein analyzing the focal plane comprises analyzing the position, flatness, orientation relative to the sample and detector, and/or thickness of the optical focal plane.

120. The method of claim 115, wherein analyzing the camera parameters comprises analyzing one or more of a noise pattern, a relative alignment, an orientation, or a magnification of the camera.

121. The method of claim 115, wherein analyzing the detection parameters comprises analyzing one or more of aberrations, sensitivity, and resolution.

122. The method of claim 121, wherein analyzing aberrations comprises analyzing one or more of spherical aberrations, chromatic aberrations, coma aberrations, and trefoil aberrations.

123. The method of claim 114, wherein analyzing the acquisition parameters comprises analyzing temporal parameters and/or spatial parameters.

124. The method of claim 123, wherein analyzing the temporal parameters comprises analyzing one or more of framerate, exposure time, number of frames, or channels.

125. The method of claim 123, wherein analyzing the spatial parameters comprise analyzing one or more of a field of view (FOV) size on a detector chip, a FOV position on a detector chip, a FOV position, or a FOV orientation in the sample.

126. The method of claim 114, wherein analyzing the SMT parameters comprise analyzing single-molecule localization and/or single-molecule tracking.

127. The method of claim 126, wherein analyzing the single-molecule localization comprise analyzing one or more of a localization error, a number of spots, or a signal to noise ratio (SNR).

128. The method of claim 123, wherein analyzing the single-molecule tracking comprise analyzing one or more of a number of tracks, a track length, a jump length, or mean posterior diffusion coefficient.

129. The method of claim 114, wherein microscope performance characteristics are selected from: oblique line scanning (OLS) alignment characteristics: rotation relative to the camera, position in the FOV, angle of inclination, excitation fluence; oblique line scanning (OLS) homogeneity characteristics: coefficient of variation (CV), Sag, fringes, thickness, mechanical and temperature effects; detection characteristics: background and camera noise, point spread function (PSF), signal to noise ratio (SNR), diffusion characteristics, optical aberrations, correction collar settings, spatial resolution, Strehl ratio, FOV homogeneity, camera rotation relative to the sample; acquisition characteristics: plate position and level, scanning amplitude, scanning offset, galvanometer (galvo) scanning, camera synchronization.

130. The method of any one of claims 114, wherein the method further comprises comparing the results of each of the imaging parameters, the acquisition parameters and the single molecule tracking (SMT) parameters with reference parameter values, wherein a deviation from the reference parameter value indicates a need for adjustment of the microscope.

131. The method of claim 130, wherein the method further comprises automated adjustment of the microscope based on the integrated analysis.
